(19) United States
(12) Patent Application Publication
(10) Pub. No.: US 2023/0057199 A1
(43) Pub. Date: Feb. 23, 2023

(54) Optical Imaging Lens Assembly

(71) Applicant: ZHEJIANG SUNNY OPTICS CO., LTD., Ningbo (CN)

(72) Inventors: Xiaoxiao ZHU, Ningbo (CN); Chen CHEN, Ningbo (CN); Wuchao XU, Ningbo (CN); Fujian DAI, Ningbo (CN); Liefeng ZHAO, Ningbo (CN)

(21) Appl. No.: 17/752,885

(22) Filed: May 25, 2022

(30) Foreign Application Priority Data
Aug. 3, 2021 (CN) 202110885447.1

(51) Int. Cl. G02B 9/64; G02B 13/00

(52) U.S. Cl. CPC G02B 9/64; G02B 13/0045

(57) ABSTRACT

The disclosure provides an optical imaging lens assembly, which sequentially includes from an object side to an image side along an optical axis: a first lens with a positive refractive power, an object-side surface thereof is a convex surface, and an image-side surface thereof is a concave surface; a second lens with a negative refractive power; a third lens with a refractive power; a fourth lens with a refractive power; a fifth lens with a positive refractive power; a sixth lens with a refractive power; a seventh lens with a positive refractive power; and an eighth lens with a negative refractive power. ImgH is a half of a diagonal length of an effective pixel region on an imaging surface of the optical imaging lens assembly, ImgH, an entrance pupil diameter (EPD) and a total effective focal length f of the optical imaging lens assembly satisfy: 4.3 mm<ImgH×EPD/f<5.3 mm.

### CROSS-REFERENCE TO RELATED PRESENT INVENTION(S)

The disclosure claims priority to and the benefit of Chinese Patent Present invention No. 202110885447.1, filed in the China National Intellectual Property Administration (CNIPA) on 3 Aug. 2021, which is incorporated herein by reference in its entirety.

### TECHNICAL FIELD

The disclosure relates to the technical field of the optical elements, and in particular, to an optical imaging lens assembly.

### BACKGROUND

With the rapid development of portable electronic products such as smart phones, in order to improve the competitiveness of products thereof, various manufacturers of smart phones have proposed higher design requirements for an optical imaging lens assembly mounted on a smart phone. Currently, most optical imaging lens assemblies are developing toward aspects of large image plane, wide angle, large aperture, high imaging quality, etc.

However, the structure of a conventional five-piece, six-piece, or even seven-piece lens is insufficient to effectively cope with the described challenge. Therefore, how to reasonably set the number of lenses in an optical imaging lens assembly and the structure of the lens so that the optical imaging lens assembly may satisfy the market demands, has become one of current difficulties urgently to be solved by many lens designers.

### SUMMARY

An embodiment of the disclosure provides an optical imaging lens assembly, which sequentially includes from an object side to an image side along an optical axis: a first lens with a positive refractive power, an object-side surface thereof is a convex surface, and an image-side surface thereof is a concave surface; a second lens with a negative refractive power; a third lens with a refractive power; a fourth lens with a refractive power; a fifth lens with a positive refractive power; a sixth lens with a refractive power; a seventh lens with a positive refractive power; and an eighth lens with a negative refractive power. ImgH is a half of a diagonal length of an effective pixel region on an imaging surface of the optical imaging lens assembly, and ImgH, an entrance pupil diameter (EPD) of the optical imaging lens assembly and a total effective focal length f of the optical imaging lens assembly may satisfy: 4.3 mm<ImgH×EPD/f<5.3 mm.

In an implementation mode, at least one of the object-side surface of the first lens to an image-side surface of the eighth lens is an aspheric surface.

In an implementation mode, an effective focal length f1 of the first lens, a curvature radius R1 of the object-side surface of the first lens and a curvature radius R2 of the image-side surface of the first lens may satisfy: 1.0<(R1+R2)/f1<1.5.

In an implementation mode, an effective focal length f4 of the fourth lens, an effective focal length f2 of the second lens and an effective focal length f8 of the eighth lens may satisfy: 0.9≤f4/(f2+f8)<1.9.

In an implementation mode, an effective focal length f5 of the fifth lens, an effective focal length f7 of the seventh lens and an effective focal length f3 of the third lens may satisfy: 0.7<(f5+f7)/f3<1.8.

In an implementation mode, a curvature radius R5 of an object-side surface of the third lens, a curvature radius R6 of an image-side surface of the third lens, a curvature radius R3 of an object-side surface of the second lens and a curvature radius R4 of an image-side surface of the second lens may satisfy: 1.0<(R3+R4)/(R5+R6)<1.5.

In an implementation mode, a curvature radius R13 of an object-side surface of the seventh lens and a curvature radius R14 of an image-side surface of the seventh lens may satisfy: 2.0<(R14+R13)/(R14−R13)<2.5.

In an implementation mode, f123 is a combined focal length of the first lens, the second lens and the third lens, and f123, a center thickness CT1 of the first lens on the optical axis, a center thickness CT2 of the second lens on the optical axis and a center thickness CT3 of the third lens on the optical axis may satisfy: 5.0<f123/(CT1+CT2+CT3)<7.0.

In an implementation mode, f67 is a combined focal length of the sixth lens and the seventh lens, and f67, a center thickness CT6 of the sixth lens on the optical axis, an air space T67 between the sixth lens and the seventh lens on the optical axis and a center thickness CT7 of the seventh lens on the optical axis may satisfy: 4.2<f67/(CT6+T67+CT7)<6.2.

In an implementation mode, SAG22 is a distance on the optical axis from an intersection point of an image-side surface of the second lens and the optical axis to an effective radius vertex of the image-side surface of the second lens, SAG21 is a distance on the optical axis from an intersection point of an object-side surface of the second lens and the optical axis to an effective radius vertex of the object-side surface of the second lens, SAG32 is a distance on the optical axis from an intersection point of an image-side surface of the third lens and the optical axis to an effective radius vertex of the image-side surface of the third lens, SAG31 is a distance on the optical axis from an intersection point of an object-side surface of the third lens and the optical axis to an effective radius vertex of the object-side surface of the third lens, and SAG22, SAG21, SAG32 and SAG31 may satisfy: 1.2<(SAG21+SAG22)/(SAG31+SAG32)<1.7.

In an implementation mode, a center thickness CT5 of the fifth lens on the optical axis and an edge thickness ET5 of the fifth lens may satisfy: 2.3<CT5/ET5<3.8.

In an implementation mode, an edge thickness ET6 of the sixth lens, an edge thickness ET7 of the seventh lens and an edge thickness ET8 of the eighth lens may satisfy: 1.2<(ET6+ET8)/(ET7)<2.2.

In an implementation mode, FOV is a maximum field of view of the optical imaging lens assembly, and FOV and the total effective focal length f of the optical imaging lens assembly may satisfy: 6.5 mm<f×tan(FOV/2)<7.5 mm.

In an implementation mode, ImgH is the half of the diagonal length of the effective pixel region on the imaging surface of the optical imaging lens assembly, TTL is a distance on the optical axis from the object-side surface of the first lens to the imaging surface of the optical imaging lens assembly, and ImgH and TTL may satisfy: 5.0 mm<ImgH×ImgH/TTL<6.0 mm.

Another embodiment of the disclosure provides an optical imaging lens assembly, which sequentially includes from an object side to an image side along an optical axis: a first lens with a positive refractive power, an object-side surface thereof is a convex surface, and an image-side surface thereof is a concave surface; a second lens with a negative refractive power; a third lens with a refractive power; a fourth lens with a refractive power; a fifth lens with a positive refractive power; a sixth lens with a refractive power; a seventh lens with a positive refractive power; and an eighth lens with a negative refractive power. FOV is a maximum field of view of the optical imaging lens assembly, and FOV and a total effective focal length f of the optical imaging lens assembly may satisfy: 6.5 mm<f×tan(FOV/2)<7.5 mm.

In an implementation mode, an effective focal length f1 of the first lens, a curvature radius R1 of the object-side surface of the first lens and a curvature radius R2 of the image-side surface of the first lens may satisfy: 1.0<(R1+R2)/f1<1.5.

In an implementation mode, an effective focal length f4 of the fourth lens, an effective focal length f2 of the second lens and an effective focal length f8 of the eighth lens may satisfy: 0.9<f4/(f2+f8)<1.9.

In an implementation mode, an effective focal length f5 of the fifth lens, an effective focal length f7 of the seventh lens and an effective focal length f3 of the third lens may satisfy: 0.7<(f5+f7)/f3<1.8.

In an implementation mode, a curvature radius R5 of an object-side surface of the third lens, a curvature radius R6 of an image-side surface of the third lens, a curvature radius R3 of an object-side surface of the second lens and a curvature radius R4 of an image-side surface of the second lens may satisfy: 1.0<(R3+R4)/(R5+R6)<1.5.

In an implementation mode, a curvature radius R13 of an object-side surface of the seventh lens and a curvature radius R14 of an image-side surface of the seventh lens may satisfy: 2.0<(R14+R13)/(R14−R13)<2.5.

In an implementation mode, f123 is a combined focal length of the first lens, the second lens and the third lens, and f123, a center thickness CT1 of the first lens on the optical axis, a center thickness CT2 of the second lens on the optical axis and a center thickness CT3 of the third lens on the optical axis may satisfy: 5.0<f123/(CT1+CT2+CT3)<7.0.

In an implementation mode, f67 is a combined focal length of the sixth lens and the seventh lens, and f67, a center thickness CT6 of the sixth lens on the optical axis, an air space T67 between the sixth lens and the seventh lens on the optical axis and a center thickness CT7 of the seventh lens on the optical axis may satisfy: 4.2<f67/(CT6+T67+CT7)<6.2.

In an implementation mode, SAG22 is a distance on the optical axis from an intersection point of an image-side surface of the second lens and the optical axis to an effective radius vertex of the image-side surface of the second lens, SAG21 is a distance on the optical axis from an intersection point of an object-side surface of the second lens and the optical axis to an effective radius vertex of the object-side surface of the second lens, SAG32 is a distance on the optical axis from an intersection point of an image-side surface of the third lens and the optical axis to an effective radius vertex of the image-side surface of the third lens, SAG31 is a distance on the optical axis from an intersection point of an object-side surface of the third lens and the optical axis to an effective radius vertex of the object-side surface of the third lens, and SAG22, SAG21, SAG32 and SAG31 may satisfy: 1.2<(SAG21+SAG22)/(SAG31+SAG32)<1.7.

In an implementation mode, a center thickness CT5 of the fifth lens on the optical axis and an edge thickness ET5 of the fifth lens may satisfy: 2.3<CT5/ET5<3.8.

In an implementation mode, an edge thickness ET6 of the sixth lens, an edge thickness ET7 of the seventh lens and an edge thickness ET8 of the eighth lens may satisfy: 1.2<(ET6+ET8)/(ET7)<2.2.

In an implementation mode, ImgH is a half of a diagonal length of an effective pixel region on the imaging surface of the optical imaging lens assembly, TTL is a distance on the optical axis from the object-side surface of the first lens to the imaging surface of the optical imaging lens assembly, and ImgH and TTL may satisfy: 5.0 mm<ImgH×ImgH/TTL<6.0 mm.

In an implementation mode, ImgH is a half of a diagonal length of the effective pixel region on the imaging surface of the optical imaging lens assembly, and ImgH, an entrance pupil diameter (EPD) of the optical imaging lens assembly and a total effective focal length f of the optical imaging lens assembly may satisfy: 4.3 mm<ImgH×EPD/f<5.3 mm.

By reasonably distributing refractive powers and optimizing optical parameters, the disclosure provides an optical imaging lens assembly which may be applied to lightweight electronic products and has at least one of beneficial effects of miniaturization, large image plane, wide angle, large aperture, good imaging quality, etc.

### BRIEF DESCRIPTION OF THE DRAWINGS

Other features, objects, and advantages of the disclosure will become more apparent upon reading the following detailed description of non-limiting embodiments made with reference to the accompanying drawings:

FIG. 1 shows a structural schematic diagram of an optical imaging lens assembly according to Embodiment 1 of the disclosure;

FIGS. 2A-2D show a longitudinal aberration curve, an astigmatism curve, a distortion curve and a lateral color curve of the optical imaging lens assembly of Embodiment 1, respectively;

FIG. 3 shows a structural schematic diagram of an optical imaging lens assembly according to Embodiment 2 of the disclosure;

FIGS. 4A-4D show a longitudinal aberration curve, an astigmatism curve, a distortion curve and a lateral color curve of the optical imaging lens assembly of Embodiment 2, respectively;

FIG. 5 shows a structural schematic diagram of an optical imaging lens assembly according to Embodiment 3 of the disclosure;

FIGS. 6A-6D show a longitudinal aberration curve, an astigmatism curve, a distortion curve and a lateral color curve of the optical imaging lens assembly of Embodiment 3, respectively;

FIG. 7 shows a structural schematic diagram of an optical imaging lens assembly according to Embodiment 4 of the disclosure;

FIGS. 8A-8D show a longitudinal aberration curve, an astigmatism curve, a distortion curve and a lateral color curve of the optical imaging lens assembly of Embodiment 4, respectively;

FIG. 9 shows a structural schematic diagram of an optical imaging lens assembly according to Embodiment 5 of the disclosure;

FIGS. 10A-10D show a longitudinal aberration curve, an astigmatism curve, a distortion curve and a lateral color curve of the optical imaging lens assembly of Embodiment 5, respectively;

FIG. 11 shows a structural schematic diagram of an optical imaging lens assembly according to Embodiment 6 of the disclosure; and

FIGS. 12A-12D show a longitudinal aberration curve, an astigmatism curve, a distortion curve and a lateral color curve of the optical imaging lens assembly of Embodiment 6, respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary embodiments of the disclosure and not intended to limit the scope of the disclosure in any manner. In the whole specification, the same reference sign numbers represent the same elements. Expression “and/or” includes any or all combinations of one or more in associated items that are listed.

It should be noted that, in this description, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease of illustration. In particular, a spherical shape or an aspheric shape shown in the drawings is shown by examples. That is, the spherical shape or the aspheric shape is not limited to the spherical shape or the aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if the lens surface is a concave surface and a position of the concave surface is not defined, it indicates that the lens surface is a concave surface at least in the paraxial region. A surface of each lens closest to an object to be photographed is called an object-side surface of the lens, and a surface of each lens closest to an imaging surface is called an image-side surface of the lens.

It also should be understood that terms “include”, “including”, “have”, “contain” and/or “containing”, used in this description, represent existence of a stated feature, element and/or component but do not exclude existence or addition of one or more other features, elements, components and/or combinations thereof. In addition, expressions like “at least one in . . . ” may appear after a list of listed features not to modify an individual component in the list but to modify the listed features. Moreover, when the embodiments of the disclosure are described, “may” is used to represent “one or more embodiments of the disclosure”. Furthermore, term “exemplary” refers to an example or exemplary description.

Unless otherwise defined, all terms (including technical terms and scientific terms) used in the disclosure have the same meanings usually understood by the general technical personnel in the field of the disclosure. It also should be understood that the terms (for example, terms defined in a common dictionary) should be explained to have meanings consistent with the meanings in the context of correlation technique and cannot be explained with ideal or excessively formal meanings, unless clearly defined like this in the disclosure.

It should be noted that the embodiments in the disclosure and features in the embodiments can be combined without conflicts. The disclosure will be described below in detail with reference to the drawings and in combination with the embodiments.

The features, principles and other aspects of the disclosure will be described below in detail.

An optical imaging lens assembly according to the exemplary embodiment of the disclosure may include eight lenses with refractive powers, which are respectively a first lens, a second lens, a third lens, a fourth lens, a fifth lens, a sixth lens, a seventh lens, and an eighth lens. The eight lenses are sequentially arranged from an object side to an image side along an optical axis. There may be a spacing distance between any two adjacent lenses from the first lens to the eighth lens.

According to the exemplary embodiment of the disclosure, the first lens may have a positive refractive power, an object-side surface thereof may be a convex surface, and an image-side surface thereof may be a concave surface; the second lens may have a negative refractive power; the third lens may have a positive refractive power or a negative refractive power; the fourth lens may have a positive refractive power or a negative refractive power; the fifth lens may have a positive refractive power; the sixth lens may have a positive refractive power or a negative refractive power; the seventh lens may have a positive refractive power; and the eighth lens may have a negative refractive power. By reasonably setting the refractive powers of the first lens to the eighth lens, the disclosure may effectively balance a low-order aberration of an optical imaging lens assembly and reduce a sensitivity of tolerance.

In an exemplary embodiment, the optical imaging lens assembly according to the disclosure may satisfy: 4.3 mm<ImgH×EPD/f<5.3 mm, wherein ImgH is a half of a diagonal length of an effective pixel region on an imaging surface of the optical imaging lens assembly, EPD is an entrance pupil diameter of the optical imaging lens assembly, and f is a total effective focal length of the optical imaging lens assembly. More specifically, ImgH, EPD and f may further satisfy: 4.5 mm<ImgH×EPD/f<4.9 mm. Satisfying 4.3 mm<ImgH×EPD/f<5.3 mm facilitates a realization of a large-aperture characteristic.

In an exemplary embodiment, the optical imaging lens assembly according to the disclosure may satisfy: 1.0<(R1+R2)/f1<1.5, wherein f1 is an effective focal length of the first lens, R1 is a curvature radius of the object-side surface of the first lens, and R2 is a curvature radius of the image-side surface of the first lens. More particularly, R1, R2 and f1 may further satisfy: 1.1<(R1+R2)/f1<1.4. Satisfying 1.0<(R1+R2)/f1<1.5 may enable an optical imaging lens assembly to better achieve a deflection of an optical path, which facilitates balancing an advanced spherical aberration generated by the optical imaging lens assembly.

In an exemplary embodiment, the optical imaging lens assembly according to the disclosure may satisfy: 0.9<f4/(f2+f8)<1.9, wherein f4 is an effective focal length of the fourth lens, f2 is an effective focal length of the second lens, and f8 is an effective focal length of the eighth lens. Satisfying 0.9<f4/(f2+f8)<1.9 may effectively reduce an optical sensitivity of the second lens, the fourth lens and the eighth lens, thereby helping to achieve requirements of batch production.

In an exemplary embodiment, the optical imaging lens assembly according to the disclosure may satisfy: 0.7<(f5+f7)/f3<1.8, wherein f5 is an effective focal length of the fifth lens, f7 is an effective focal length of the seventh lens, and f3 is an effective focal length of the third lens. Satisfying 0.7<(f5+f7)/f3<1.8 may reasonably distribute the refractive powers of the third lens, the fifth lens and the seventh lens, thereby facilitating balancing an off-axis aberration of the lens and improving an ability of the lens to correct aberration.

In an exemplary embodiment, the optical imaging lens assembly according to the disclosure may satisfy: 1.0<(R3+R4)/(R5+R6)<1.5, wherein R5 is a curvature radius of an object-side surface of the third lens, R6 is a curvature radius of an image-side surface of the third lens, R3 is a curvature radius of an object-side surface of the second lens, and R4 is a curvature radius of an image-side surface of the second lens. More particularly, R3, R4, R5 and R6 may further satisfy: 1.0<(R3+R4)/(R5+R6)<1.4. Satisfying 1.0<(R3+R4)/(R5+R6)<1.5 may enable an optical imaging lens assembly to better achieve a deflection of an optical path, which facilitates balancing an advanced spherical aberration generated by the optical imaging lens assembly.

In an exemplary embodiment, the optical imaging lens assembly according to the disclosure may satisfy: 2.0<(R14+R13)/(R14−R13)<2.5, wherein R13 is a curvature radius of an object-side surface of the seventh lens, and R14 is a curvature radius of an image-side surface of the seventh lens. Satisfying 2.0<(R14+R13)/(R14−R13)<2.5 may reduce a deflection angle of light in the seventh lens, thereby preventing a strong total reflection ghost image caused by an excessive deflection angle of the light.

In an exemplary embodiment, the optical imaging lens assembly according to the disclosure may satisfy: 5.0<f123/(CT1+CT2+CT3)<7.0, wherein f123 is a combined focal length of the first lens, the second lens and the third lens, CT1 is a center thickness of the first lens on the optical axis, CT2 is a center thickness of the second lens on the optical axis, and CT3 is a center thickness of the third lens on the optical axis. More specifically, f123, CT1, CT2 and CT3 may further satisfy: 5.4≤f123/(CT1+CT2+CT3)<6.7. Satisfying 5.0<f123/(CT1+CT2+CT3)<7.0 may reasonably control a performance of a coma aberration of the lens, such that the optical imaging lens assembly has a good optical performance.

In an exemplary embodiment, the optical imaging lens assembly according to the disclosure may satisfy: 4.2<f67/(CT6+T67+CT7)<6.2, wherein f67 is a combined focal length of the sixth lens and the seventh lens, CT6 is a center thickness of the sixth lens on the optical axis, T67 is an air space between the sixth lens and the seventh lens on the optical axis, and CT7 is a center thickness of the seventh lens on the optical axis. More specifically, f67, CT6, T67 and CT7 may further satisfy: 4.4<f67/(CT6+T67+CT7)<6.1. Satisfying 4.2<f67/(CT6+T67+CT7)<6.2 may control a deflection angles of an edge field of view at the sixth lens and the seventh lens, and may effectively reduce a sensitivity of the lens.

In an exemplary embodiment, the optical imaging lens assembly according to the disclosure may satisfy: 1.2<(SAG21+SAG22)/(SAG31+SAG32)<1.7, wherein SAG22 is a distance on the optical axis from an intersection point of an image-side surface of the second lens and the optical axis to an effective radius vertex of the image-side surface of the second lens, SAG21 is a distance on the optical axis from an intersection point of an object-side surface of the second lens and the optical axis to an effective radius vertex of the object-side surface of the second lens, SAG32 is a distance on the optical axis from an intersection point of an image-side surface of the third lens and the optical axis to an effective radius vertex of the image-side surface of the third lens, and SAG31 is a distance on the optical axis from an intersection point of an object-side surface of the third lens and the optical axis to an effective radius vertex of the object-side surface of the third lens. Satisfying 1.2<(SAG21+SAG22)/(SAG31+SAG32)<1.7 may not only ensure shapes of the second lens and the third lens, but may also enable the second lens and the third lens to have a better processing process, and may also effectively balance a spherical aberration, coma aberration and astigmatism generated by the lens.

In an exemplary embodiment, the optical imaging lens assembly according to the disclosure may satisfy: 2.3<CT5/ET5<3.8, wherein CT5 is a center thickness of the fifth lens on the optical axis, and ET5 is an edge thickness of the fifth lens. Satisfying 2.3<CT5/ET5<3.8 helps to reasonably control a shape of the fifth lens.

In an exemplary embodiment, the optical imaging lens assembly according to the disclosure may satisfy: 1.2<(ET6+ET8)/(ET7)<2.2, wherein ET6 is an edge thickness of the sixth lens, ET7 is an edge thickness of the seventh lens, and ET8 is an edge thickness of the eighth lens. More specifically, ET6, ET8 and ET7 may further satisfy: 1.3<(ET6+ET8)/(ET7)<2.1. Satisfying 1.2<(ET6+ET8)/(ET7)<2.2 may not only prevent a difficult molding of the sixth lens, the seventh lens and the eighth lens due to excessively thin edges, but may also mitigate a light deflection at edges of the sixth lens to the eighth lens, so as to avoid a strong ghost image.

In an exemplary embodiment, the optical imaging lens assembly according to the disclosure may satisfy: 6.5 mm<f×tan(FOV/2)<7.5 mm, wherein f is the total effective focal length of the optical imaging lens assembly, and FOV is a maximum field of view of the optical imaging lens assembly. More specifically, f and FOV may further satisfy: 6.8 mm<f×tan(FOV/2)<7.3 mm. Satisfying 6.5 mm<f×tan(FOV/2)<7.5 mm facilitates controlling a size of an image surface of the optical imaging lens assembly.

In an exemplary embodiment, the optical imaging lens assembly according to the disclosure may satisfy: 5.0 mm<ImgH×ImgH/TTL<6.0 mm, wherein ImgH is a half of a diagonal length of an effective pixel region on the imaging surface of the optical imaging lens assembly, and TTL is a distance on the optical axis from the object-side surface of the first lens to the imaging surface of the optical imaging lens assembly. More specifically, ImgH and TTL may further satisfy: 5.1 mm<ImgH×ImgH/TTL<5.9 mm. Satisfying 5.0 mm<ImgH×ImgH/TTL<6.0 mm may realize ultrathin and large image surface characteristics, etc. of the lens.

In an exemplary embodiment, the optical imaging lens assembly according to the disclosure further includes a diaphragm arranged between the object side and the first lens. In an embodiment, the optical imaging lens assembly above may further include an optical filter for correcting chromatic aberration and/or a protective glass for protecting a photosensitive element located on the imaging surface. The disclosure provides an optical imaging lens assembly having characteristics such as miniaturization, large image surface, wide angle, large aperture and high imaging quality. The optical imaging lens assembly according to the embodiments above of the disclosure may adopt multiple lenses, for example, eight lenses as described above. By reasonably distributing the refractive power, surface type and material of each lens, the center thickness of each lens, and the on-axis spacing distance between each lenses and the like, incident light rays may be effectively converged, an optical total length of the imaging lens may be reduced, and the processability of the imaging lens may be improved, so that the optical imaging lens assembly is more beneficial to production and processing.

In embodiments of the disclosure, at least one of the lens surfaces of each lens is an aspheric surface, that is, at least one of the object-side surface of the first lens to an image-side surface of the eighth lens is an aspheric surface. The aspheric lens has the features that the curvature varies continuously from the center of the lens to the periphery of the lens. Unlike a spherical lens having a constant curvature from the center of the lens to the periphery of the lens, an aspheric lens has better curvature radius characteristics, and has the advantages of improving distortion aberration and improving astigmatism aberration. By adopting the aspheric lens, the aberration occurring during imaging may be eliminated as much as possible, thereby improving the imaging quality. In an embodiment, at least one of the object-side surface and the image-side surface of each of the first lens, the second lens, the third lens, the fourth lens, the fifth lens, the sixth lens, the seventh lens and the eighth lens is an aspheric surface. In another embodiment, the object-side surface and the image-side surface of each lens of the first lens, the second lens, the third lens, the fourth lens, the fifth lens, the sixth lens, the seventh lens and the eighth lens are both aspheric surfaces.

However, those skilled in the art should know that the number of the lenses forming the optical imaging lens assembly may be changed without departing from the technical solutions claimed in the disclosure to achieve each result and advantage described in the description. For example, although descriptions are made in the embodiment with eight lenses as an example, the optical imaging lens assembly is not limited to eight lenses. If necessary, the optical imaging lens assembly may further include another number of lenses.

Specific embodiments of the optical imaging lens assembly applicable to the embodiments above are further described below with reference to the accompanying drawings.

### Embodiment 1

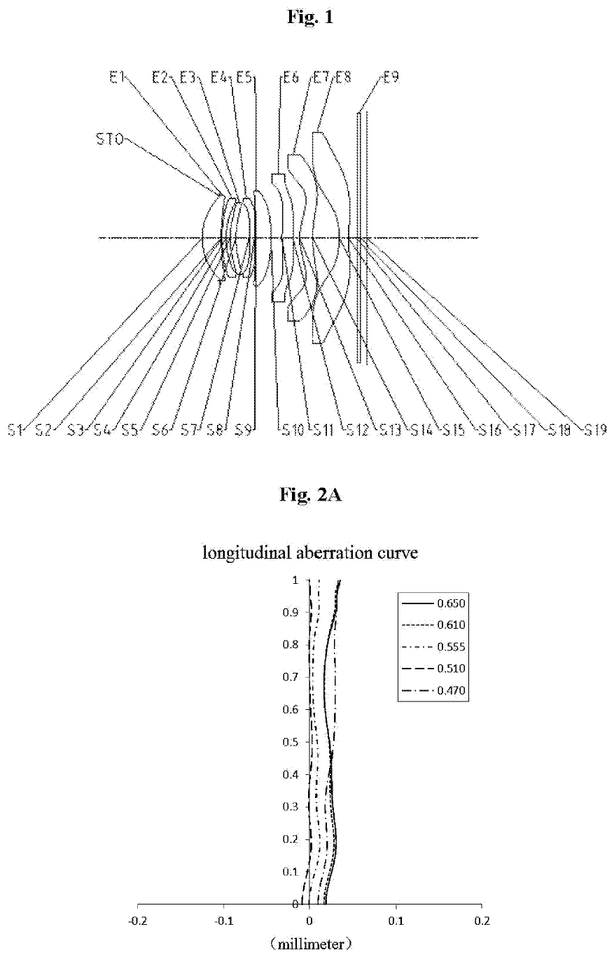

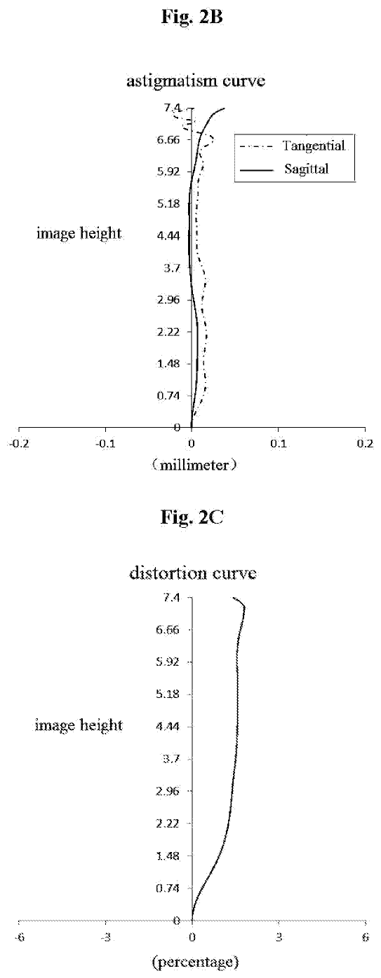

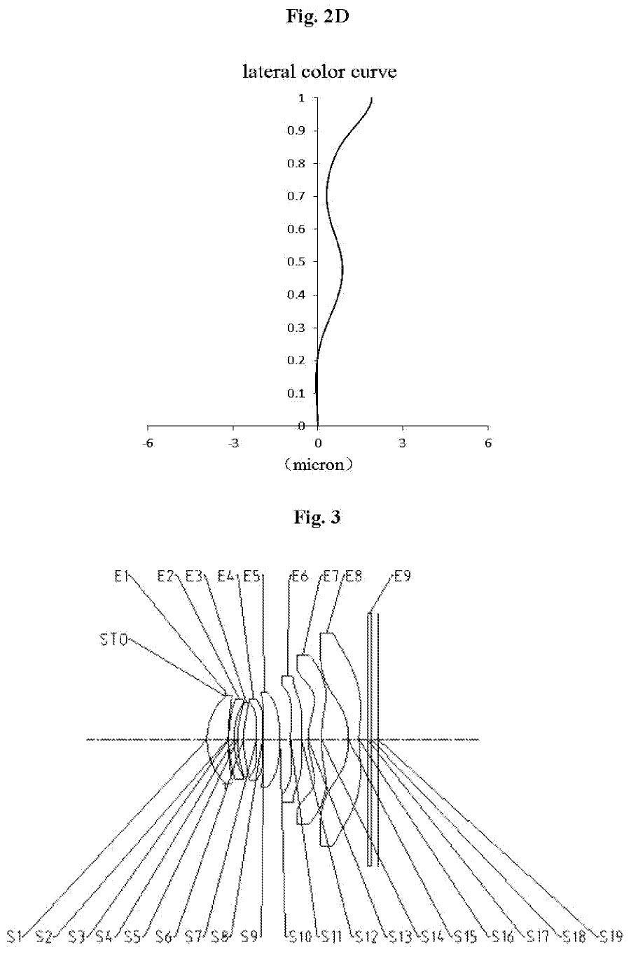

An optical imaging lens assembly according to Embodiment 1 of the disclosure is described below with reference to FIGS. 1-2D. FIG. 1 shows a structural schematic diagram of an optical imaging lens assembly according to Embodiment 1 of the disclosure.

As shown in FIG. 1, the optical imaging lens assembly includes sequentially from an object side to an image side: a diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

Table 1 shows a basic parameter table of the optical imaging lens assembly of Embodiment 1, wherein units of the curvature radius, the thickness/distance, and the focal length are all millimeters (mm).

TABLE 1

| | | | | Materials | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | 2000.0000 | | | | |
| STO | Spherical | Infinity | −0.9913 | | | | |
| S1 | Aspheric | 3.3950 | 1.0805 | 1.54 | 56.1 | 9.38 | 0.0000 |
| S2 | Aspheric | 8.9639 | 0.0514 | | | | 0.0000 |
| S3 | Aspheric | 6.4777 | 0.2500 | 1.67 | 19.2 | −20.24 | 0.0000 |
| S4 | Aspheric | 4.3309 | 0.2219 | | | | 0.0000 |
| S5 | Aspheric | 3.9400 | 0.3400 | 1.54 | 56.1 | 35.26 | 0.0000 |
| S6 | Aspheric | 4.8042 | 0.7570 | | | | 0.0000 |
| S7 | Aspheric | 23.5466 | 0.3100 | 1.67 | 19.2 | −33.31 | 0.0000 |
| S8 | Aspheric | 11.4631 | 0.0632 | | | | 0.0000 |
| S9 | Aspheric | 80.0994 | 0.8818 | 1.54 | 56.1 | 20.86 | 0.0000 |
| S10 | Aspheric | −13.2018 | 0.6375 | | | | 0.0000 |
| S11 | Aspheric | 11.4218 | 0.6253 | 1.57 | 37.3 | −84.66 | 0.0000 |
| S12 | Aspheric | 9.0532 | 0.3984 | | | | 0.0000 |
| S13 | Aspheric | 3.1515 | 0.7424 | 1.54 | 56.1 | 8.96 | −1.0000 |
| S14 | Aspheric | 8.1393 | 1.5237 | | | | 0.0000 |
| S15 | Aspheric | −6.3779 | 0.5360 | 1.54 | 55.7 | −5.76 | 0.0000 |
| S16 | Aspheric | 6.1952 | 0.4785 | | | | −1.0000 |
| S17 | Spherical | Infinity | 0.2100 | 1.52 | 64.2 | | |
| S18 | Spherical | Infinity | 0.3775 | | | | |
| S19 | Spherical | Infinity | | | | | |

In the embodiment, f is a total effective focal length of the optical imaging lens assembly, and f is 7.61 mm, TTL is a total length of the optical imaging lens assembly (i.e. a distance on the optical axis from the object-side surface S1 of the first lens E1 to the imaging surface S19 of the optical imaging lens assembly), and TTL is 9.48 mm, ImgH is a half of a diagonal length of an effective pixel region on the imaging surface S19 of the optical imaging lens assembly, and ImgH is 7.39 mm.

In Embodiment 1, both the object-side surface and the image-side surface of any lens of the first lens E1 to the eighth lens E8 are both aspheric surfaces, and a surface type x of each aspheric lens can be defined by, but is not limited to, the following aspheric formula:

$$\text{?} = \frac{\text{?}}{\text{?}} + \sum \text{?} \qquad ( 1 )$$

$$\text{?} \text{indicates text missing or illegible when filed}$$

wherein x is a vector height of a distance between the aspheric surface and a vertex of the aspheric surface when the aspheric surface is located at a position with the height h in an optical axis direction: c is a paraxial curvature of the aspheric surface, c=1/R (that is, the paraxial curvature c is a reciprocal of the curvature radius R in Table 1 above): k is a conic coefficient: and Ai is a correction coefficient of the i-th order of the aspheric surface. Tables 2-1 and 2-2 below show high-order coefficients A4, A6, A8, A10, A12, A14, A16, A18, A20, A22, A24, A26, A28 and A30 that may be used for each of the aspheric lens surfaces S1-S16 in Embodiment 1.

TABLE 2-1

| Surface | | | | | | | |
|---|---|---|---|---|---|---|---|
| number | A4 | A6 | A8 | A10 | A12 | A14 | A16 |
| S1 | −6.5071E−05 | 8.8208E−04 | −1.1197E−03 | 7.9190E−04 | −3.3589E−04 | 8.7564E−05 | −1.3781E−05 |
| S2 | −3.1807E−03 | −3.1205E−03 | 1.3263E−03 | 3.8143E−05 | −1.5918E−04 | 5.0518E−05 | −7.6670E−06 |
| S3 | −3.9117E−03 | 4.8200E−04 | −1.3223E−03 | 1.2408E−03 | −4.5734E−04 | 8.1985E−05 | −5.7179E−06 |
| S4 | −7.2420E−03 | 6.4716E−03 | −4.1780E−03 | 1.8233E−03 | 4.1741E−04 | 2.3562E−05 | 9.7370E−06 |
| S5 | −1.5923E−02 | 3.4806E−03 | −1.4222E−03 | 1.5971E−05 | 2.4015E−04 | −1.1910E−04 | 2.9225E−05 |
| S6 | −7.4682E−03 | −9.1751E−05 | 4.5245E−04 | −6.4828E−04 | 3.7549E−04 | −1.2515E−04 | 2.6168E−05 |
| S7 | −2.2731E−02 | 1.7342E−02 | −4.9267E−02 | 8.7490E−02 | −1.0859E−01 | 9.6315E−02 | −6.2027E−02 |
| S8 | −2.3533E−02 | 1.6928E−02 | −2.5303E−02 | 2.3566E−02 | −1.4890E−02 | 5.8005E−03 | −8.7387E−04 |
| S9 | −1.0002E−02 | 1.4515E−02 | −1.9710E−02 | 1.9807E−02 | −1.5739E−02 | 9.4302E−03 | 4.0768E−03 |
| S10 | −1.0999E−02 | 2.5085E−03 | −9.6067E−04 | −6.0004E−04 | 1.1648E−03 | −8.4839E−04 | 3.8272E−04 |
| S11 | −1.8555E−02 | 7.9334E−03 | −2.5689E−03 | −3.1133E−05 | 4.5042E−04 | −2.5808E−04 | 8.9082E−05 |
| S12 | −4.6321E−02 | 1.8024E−02 | −5.8650E−03 | 1.4938E−03 | −3.4660E−04 | 8.0000E−05 | −1.6926E−05 |
| S13 | −2.7317E−02 | 5.4876E−03 | −1.8812E−03 | 7.8202E−04 | −3.0603E−04 | 8.5310E−05 | −1.6253E−05 |
| S14 | 9.6592E−03 | −7.5318E−03 | 2.8947E−03 | −8.4081E−04 | 1.7015E−04 | −2.3892E−05 | 2.3497E−06 |
| S15 | −2.1687E−02 | 1.0821E−03 | 1.0604E−03 | −3.6321E−04 | 6.6501E−05 | −7.8981E−06 | 6.4315E−07 |
| S16 | −2.3462E−02 | 2.6499E−03 | −1.8538E−05 | −6.1604E−05 | 1.3467E−05 | −1.6527E−06 | 1.3555E−07 |

TABLE 2-2

| Surface | | | | | | | |
|---|---|---|---|---|---|---|---|
| number | A18 | A20 | A22 | A24 | A26 | A28 | A30 |
| S1 | 1.2016E−06 | −4.4644E−08 | 0.0000E−00 | 0.0000E−00 | 0.0000E−00 | 0.0000E−00 | 0.0000E−00 |
| S2 | 5.8911E−07 | −1.8418E−08 | 0.0000E−00 | 0.0000E−00 | 0.0000E−00 | 0.0000E−00 | 0.0000E−00 |
| S3 | −1.6833E−07 | 2.4198E−08 | 1.0336E−09 | 0.0000E−00 | 0.0000E−00 | 0.0000E−00 | 0.0000E−00 |
| S4 | −1.8038E−06 | 3.6690E−08 | 7.6356E−09 | 0.0000E−00 | 0.0000E−00 | 0.0000E−00 | 0.0000E−00 |
| S5 | −3.5051E−06 | 1.6263E−07 | 0.0000E−00 | 0.0000E−00 | 0.0000E−00 | 0.0000E−00 | 0.0000E−00 |
| S6 | −2.9946E−06 | 1.4540E−07 | 0.0000E−00 | 0.0000E−00 | 0.0000E−00 | 0.0000E−00 | 0.0000E−00 |
| S7 | 2.9206E−02 | −1.0033E−02 | 2.4826E−03 | −4.3046E−04 | 4.9589E−05 | −3.4074E−06 | 1.0566E−07 |
| S8 | −3.36331E−04 | 2.6206E−04 | −7.8606E−05 | 1.3923E−05 | −1.5050E−06 | 9.2201E−08 | −2.4619E−09 |
| S9 | 1.2256E−03 | −2.7478E−04 | 4.2394E−05 | −4.5076E−06 | 3.1448E−07 | −1.2961E−08 | 2.3926E−10 |
| S10 | −1.1742E−04 | 2.5134E−05 | −3.7539E−06 | −3.8335E−07 | −2.5504E−08 | 9.9559E−10 | −1.7290E−11 |
| S11 | −2.1454E−05 | 3.7133E−06 | −4.5940E−07 | 3.9538E−08 | −2.2427E−09 | 7.5206E−11 | −1.1276E−12 |
| S12 | 2.8824E−06 | −3.6380E−07 | 3.2593E−08 | −2.0014E−09 | 7.9947E−11 | −1.8711E−12 | 1.9472E−14 |
| S13 | 2.1437E−06 | −1.9777E−07 | 1.2737E−08 | −5.6177E−10 | 1.6188E−11 | −2.7485E−13 | 2.0867E−15 |
| S14 | −1.6158E−07 | 7.6096E−09 | −2.3246E−10 | 3.9721E−12 | −1.5993E−14 | −5.9330E−16 | 7.5197E−18 |
| S15 | −3.6888E−08 | 1.5067E−09 | −4.3660E−11 | 8.7839E−13 | −1.1681E−14 | 9.2429E−17 | −3.2976E−19 |
| S16 | −7.7992E−09 | 3.1919E−10 | −9.2462E−12 | 1.8522E−13 | −2.4398E−15 | 1.9011E−17 | −6.6397E−20 |

FIG. 2A shows a longitudinal aberration curve of the optical imaging lens assembly of Embodiment 1, which represents deviations of a convergence focal point after lights with different wavelengths pass through the lens. FIG. 2B shows an astigmatism curve of the optical imaging lens assembly of Embodiment 1, which represents a tangential image surface curvature and a sagittal image surface curvature. FIG. 2C shows a distortion curve of the optical imaging lens assembly of Embodiment 1, which represents distortion values corresponding to different image heights. FIG. 2D shows a lateral color curve of the optical imaging lens assembly of Embodiment 1, which represents deviations of different image heights on the imaging surface after light passes through the lens. According to FIGS. 2A-2D, the optical imaging lens assembly provided in Embodiment 1 may achieve a good imaging quality.

### Embodiment 2

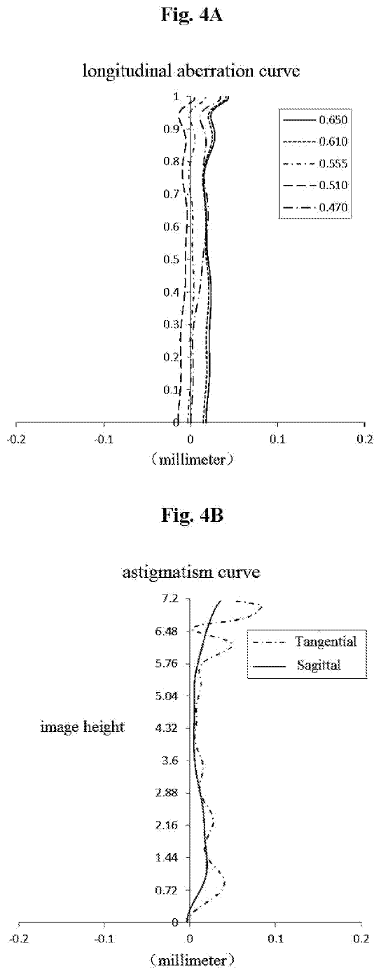

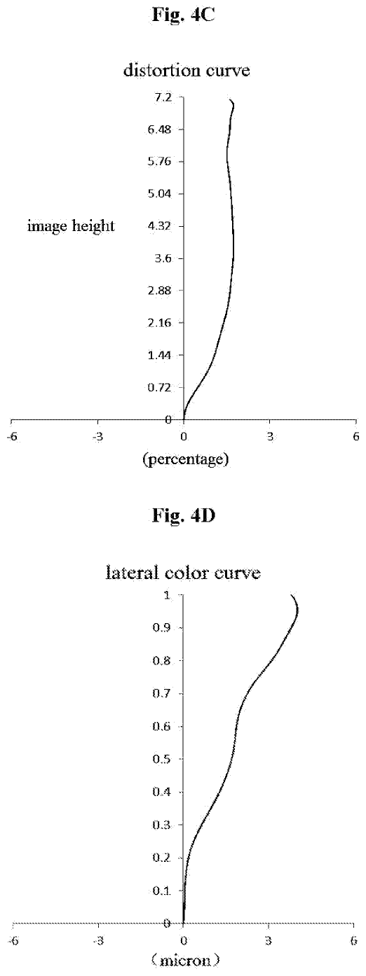

An optical imaging lens assembly according to Embodiment 2 of the disclosure is described below with reference to FIGS. 3-4D. In the embodiment and the following embodiments, for brevity, some description similar to Embodiment 1 is omitted. FIG. 3 shows a structural schematic diagram of an optical imaging lens assembly according to Embodiment 2 of the disclosure.

As shown in FIG. 3, the optical imaging lens assembly includes sequentially from an object side to an image side: a diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a concave surface, and an image-side surface S10 thereof is a convex surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 7.65 mm, TTL is a total length of the optical imaging lens assembly, and TTL is 9.59 mm, ImgH is a half of a diagonal length of an effective pixel region on the imaging surface S19 of the optical imaging lens assembly, and ImgH is 7.15 mm.

Table 3 shows a basic parameter table of the optical imaging lens assembly of Embodiment 2, wherein units of the curvature radius, the thickness/distance, and the focal length are all millimeters (mm). Tables 4-1 and 4-2 show high-order coefficients which may be used for each aspheric lens surface in Embodiment 2, wherein each aspheric surface type may be defined by formula (1) given in Embodiment 1 above.

TABLE 3

| | | | | Materials | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | 2000.0000 | | | | |
| STO | Spherical | Infinity | −1.0000 | | | | |
| S1 | Aspheric | 3.4423 | 1.1798 | 1.54 | 56.1 | 9.56 | −0.0005 |
| S2 | Aspheric | 8.9077 | 0.0438 | | | | −0.1141 |
| S3 | Aspheric | 6.7811 | 0.2877 | 1.67 | 19.2 | −19.95 | 0.1011 |
| S4 | Aspheric | 4.4385 | 0.1940 | | | | −0.0448 |
| S5 | Aspheric | 4.1563 | 0.3500 | 1.54 | 56.1 | 31.22 | 0.0336 |
| S6 | Aspheric | 5.3344 | 0.7210 | | | | 0.0734 |
| S7 | Aspheric | 26.4902 | 0.3264 | 1.67 | 19.2 | −43.95 | −3.2455 |
| S8 | Aspheric | 13.9495 | 0.0923 | | | | 2.7756 |
| S9 | Aspheric | −100.0000 | 0.8963 | 1.54 | 56.1 | 23.93 | 50.0000 |
| S10 | Aspheric | −11.5827 | 0.5910 | | | | 0.2771 |
| S11 | Aspheric | 12.3717 | 0.6098 | 1.57 | 37.3 | −60.00 | 1.2492 |
| S12 | Aspheric | 8.9242 | 0.3761 | | | | −0.0356 |
| S13 | Aspheric | 3.1433 | 0.7506 | 1.54 | 56.1 | 8.68 | −0.9861 |
| S14 | Aspheric | 8.5609 | 1.5031 | | | | 0.3980 |
| S15 | Aspheric | −6.3858 | 0.6032 | 1.54 | 55.7 | −5.76 | −0.0040 |
| S16 | Aspheric | 6.1934 | 0.4789 | | | | −0.0017 |
| S17 | Spherical | Infinity | 0.2100 | 1.52 | 64.2 | | |
| S18 | Spherical | Infinity | 0.3778 | | | | |
| S19 | Spherical | Infinity | | | | | |

TABLE 4-1

| Surface number | A4 | A6 | A8 | A10 | A12 | A14 | A16 |
|---|---|---|---|---|---|---|---|
| S1 | 1.0484E−04 | 4.5006E−04 | −6.0352E−04 | 4.2937E−04 | −1.8073E−04 | 4.6561E−05 | −7.2403E−06 |
| S2 | −3.9308E−03 | −4.3399E−04 | −2.2564E−03 | 2.4440E−03 | −1.1025E−03 | 2.7784E−04 | −4.0922E−05 |
| S3 | −4.4462E−03 | 2.9560E−03 | −4.4184E−03 | 3.1414E−03 | −1.1097E−03 | 2.0497E−04 | −1.4849E−05 |
| S4 | −8.3626E−03 | 8.4178E−03 | −5.5699E−03 | 1.9646E−03 | 7.5750E−05 | −3.7678E−04 | 1.6417E−04 |
| S5 | −1.6710E−02 | 4.2696E−03 | −1.3982E−03 | −4.1418E−04 | 5.5763E−04 | −2.3010E−04 | 4.8917E−05 |
| S6 | −8.3227E−03 | 2.5096E−03 | −3.5021E−03 | 3.0113E−03 | −1.7271E−03 | 6.2980E−04 | −1.3932E−04 |
| S7 | −2.3667E−02 | 2.2857E−02 | −6.6501E−02 | 1.2094E−01 | −1.5168E−01 | 1.3491E−01 | −8.6877E−02 |
| S8 | −2.3680E−02 | 2.1168E−02 | −4.3475E−02 | 5.8059E−02 | −5.4479E−02 | 3.6742E−02 | −1.8138E−02 |
| S9 | −8.2597E−03 | 1.0753E−02 | −1.7610E−02 | 1.9807E−02 | −1.5647E−02 | 8.8011E−03 | −3.5419E−03 |
| S10 | −1.0424E−02 | 1.5660E−03 | −4.6464E−04 | −4.4710E−05 | 1.6255E−05 | 9.5421E−05 | −8.5734E−05 |
| S11 | −1.8475E−02 | 9.4234E−03 | −5.7739E−03 | 3.2249E−03 | −1.5859E−03 | 6.0248E−04 | −1.6696E−04 |
| S12 | −4.4679E−02 | 1.5866E−02 | −4.6166E−03 | 1.0855E−03 | −2.8017E−04 | 8.3741E−05 | −2.1679E−05 |
| S13 | −2.7618E−02 | 6.4397E−03 | −3.5940E−03 | 2.0536E−03 | −8.5888E−04 | 2.4411E−04 | −4.7761E−05 |
| S14 | 1.1699E−02 | −9.6243E−03 | 3.9332E−03 | −1.1971E−03 | 2.6019E−04 | −4.0185E−05 | 4.4235E−06 |
| S15 | −2.3072E−02 | 2.8942E−03 | 1.8672E−04 | −1.3871E−04 | 3.0777E−05 | −4.1011E−06 | 3.6196E−07 |
| S16 | −2.4602E−02 | 2.8988E−03 | 4.4503E−05 | −1.1347E−04 | 2.7088E−05 | −3.7113E−06 | 3.3846E−07 |

TABLE 4-2

| Surface number | A18 | A20 | A22 | A24 | A26 | A28 | A30 |
|---|---|---|---|---|---|---|---|
| S1 | 6.2460E−07 | −2.3044E−08 | 0.0000E+00 | 0.0000E+00 | 0.0000E+00 | 0.0000E+00 | 0.0000E+00 |
| S2 | 3.2999E−06 | −1.1284E−07 | 0.0000E+00 | 0.0000E+00 | 0.0000E+00 | 0.0000E+00 | 0.0000E+00 |
| S3 | −9.9925E−07 | 2.3337E−07 | −1.0591E−08 | 0.0000E+00 | 0.0000E+00 | 0.0000E+00 | 0.0000E+00 |
| S4 | −3.5371E−05 | 3.9870E−06 | −1.8819E−07 | 0.0000E+00 | 0.0000E+00 | 0.0000E+00 | 0.0000E+00 |
| S5 | −5.0700E−06 | 1.9666E−07 | 0.0000E+00 | 0.0000E+00 | 0.0000E+00 | 0.0000E+00 | 0.0000E+00 |
| S6 | 1.7296E−05 | −9.2195E−07 | 0.0000E+00 | 0.0000E+00 | 0.0000E+00 | 0.0000E+00 | 0.0000E+00 |
| S7 | 4.0920E−02 | −1.4101E−02 | 3.5150E−03 | −6.1703E−04 | 7.2341E−05 | −5.0846E−06 | 1.6203E−07 |
| S8 | 6.6314E−03 | −1.7987E−03 | 3.5797E−04 | −5.0829E−05 | 4.8751E−06 | −2.8289E−07 | 7.4952E−09 |
| S9 | 1.0262E−03 | −2.1456E−04 | 3.2145E−05 | −3.3724E−06 | 2.3574E−07 | −9.8811E−09 | 1.8816E−10 |
| S10 | 3.7211E−05 | −9.9513E−06 | 1.7456E−06 | −2.0170E−07 | 1.4789E−08 | −6.2265E−10 | 1.1431E−11 |
| S11 | 3.3199E−05 | −4.6943E−06 | 4.6492E−07 | −3.1285E−08 | 1.3490E−09 | −3.3091E−11 | 3.4136E−13 |
| S12 | 4.0964E−06 | −5.3950E−07 | 4.8812E−08 | −2.9735E−09 | 1.1660E−10 | −2.6604E−12 | 2.6862E−14 |
| S13 | 6.5390E−06 | −6.3091E−07 | 4.2697E−08 | −1.9845E−09 | 6.0381E−11 | −1.0841E−12 | 8.7169E−15 |
| S14 | −3.4681E−07 | 1.9205E−08 | −7.3571E−10 | 1.8693E−11 | −2.8979E−13 | 2.2766E−15 | −4.9518E−18 |
| S15 | −2.2048E−08 | 9.4405E−10 | −2.8428E−11 | 5.9065E−13 | −8.0739E−15 | 6.5432E−17 | −2.3845E−19 |
| S16 | −2.1500E−08 | 9.6523E−10 | −3.0516E−11 | 6.6467E−13 | −9.4949E−15 | 8.0078E−17 | −3.0226E−19 |

FIG. 4A shows a longitudinal aberration curve of the optical imaging lens assembly of Embodiment 2, which represents deviations of a convergence focal point after lights with different wavelengths pass through the lens. FIG. 4B shows an astigmatism curve of the optical imaging lens assembly of Embodiment 2, which represents a tangential image surface curvature and a sagittal image surface curvature. FIG. 4C shows a distortion curve of the optical imaging lens assembly of Embodiment 2, which represents distortion values corresponding to different image heights. FIG. 4D shows a lateral color curve of the optical imaging lens assembly of Embodiment 2, which represents deviations of different image heights on the imaging surface after light passes through the lens. According to FIGS. 4A-4D, the optical imaging lens assembly provided in Embodiment 2 may achieve a good imaging quality.

### Embodiment 3

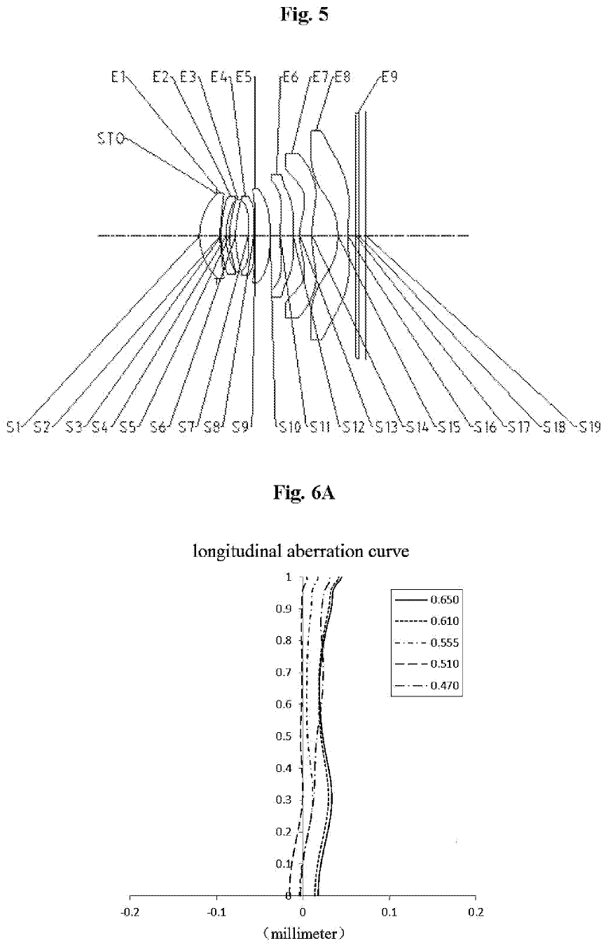

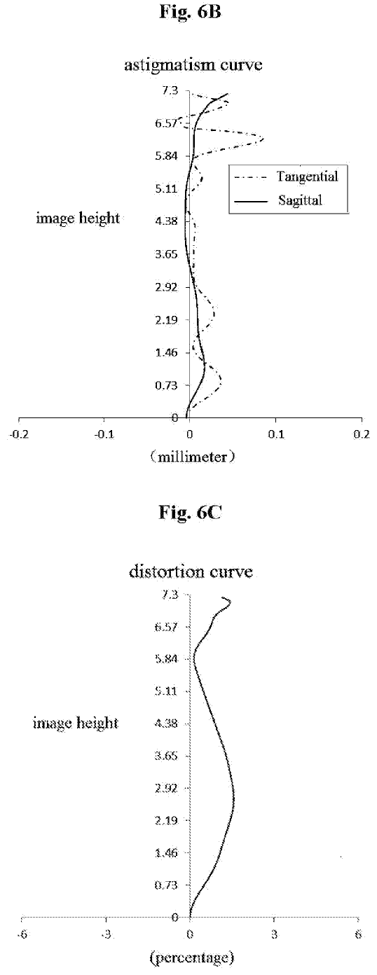

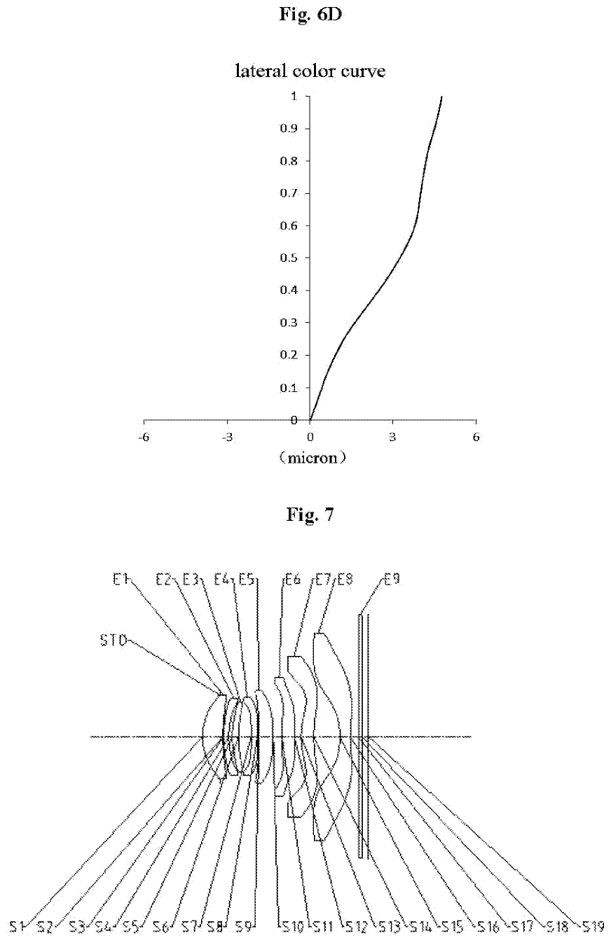

An optical imaging lens assembly according to Embodiment 3 of the disclosure is described below with reference to FIGS. 5-6D. FIG. 5 shows a structural schematic diagram of an optical imaging lens assembly according to Embodiment 3 of the disclosure.

As shown in FIG. 5, the optical imaging lens assembly includes sequentially from an object side to an image side: a diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a convex surface, and an image-side surface S8 thereof is a concave surface. The fifth lens E5 has a positive refractive power, an object-side surface S9 thereof is a concave surface, and an image-side surface S10 thereof is a convex surface. The sixth lens E6 has a positive refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 7.66 mm, TTL is a total length of the optical imaging lens assembly, and TTL is 9.65 mm, ImgH is a half of a diagonal length of an effective pixel region on the imaging surface S19 of the optical imaging lens assembly, and ImgH is 7.25 mm.

Table 5 shows a basic parameter table of the optical imaging lens assembly of Embodiment 3, wherein units of the curvature radius, the thickness/distance, and the focal length are all millimeters (mm). Tables 6-1 and 6-2 show high-order coefficients which may be used for each aspheric lens surface in Embodiment 3, wherein each aspheric surface type may be defined by formula (1) given in Embodiment 1 above.

TABLE 5

| | | | | Materials | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | 2000.0000 | | | | |
| STO | Spherical | Infinity | −0.9738 | | | | |
| S1 | Aspheric | 3.4515 | 1.2006 | 1.54 | 56.1 | 9.52 | 0.0056 |
| S2 | Aspheric | 9.0184 | 0.0549 | | | | −0.1985 |
| S3 | Aspheric | 6.8710 | 0.2905 | 1.67 | 19.2 | −19.59 | 0.0960 |
| S4 | Aspheric | 4.4498 | 0.1929 | | | | −0.0355 |
| S5 | Aspheric | 4.2032 | 0.3518 | 1.54 | 56.1 | 30.38 | 0.0369 |
| S6 | Aspheric | 5.4653 | 0.7322 | | | | 0.0462 |
| S7 | Aspheric | 26.1585 | 0.3252 | 1.67 | 19.2 | −40.37 | −20.8235 |
| S8 | Aspheric | 13.3043 | 0.0944 | | | | 3.2677 |
| S9 | Aspheric | −100.0000 | 0.8464 | 1.54 | 56.1 | 32.12 | −50.0000 |
| S10 | Aspheric | −14.9523 | 0.5910 | | | | 4.4927 |
| S11 | Aspheric | 10.1129 | 0.7434 | 1.57 | 37.3 | 66.61 | 0.2081 |
| S12 | Aspheric | 13.4132 | 0.3984 | | | | 0.4945 |
| S13 | Aspheric | 3.5628 | 0.7122 | 1.54 | 56.1 | 10.38 | −0.9594 |
| S14 | Aspheric | 8.9327 | 1.4824 | | | | 0.3603 |
| S15 | Aspheric | −6.3836 | 0.5742 | 1.54 | 55.7 | −5.76 | −0.0040 |
| S16 | Aspheric | 6.1966 | 0.4785 | | | | −0.0023 |
| S17 | Spherical | Infinity | 0.2100 | 1.52 | 64.2 | | |
| S18 | Spherical | Infinity | 0.3774 | | | | |
| S19 | Spherical | Infinity | | | | | |

TABLE 6-1

| Surface number | A4 | A6 | A8 | A10 | A12 | A14 | A16 |
|---|---|---|---|---|---|---|---|
| S1 | 4.8163E−04 | −2.9126E−04 | 1.3483E−04 | −1.0279E−05 | −1.8758E−05 | 9.3989E−06 | −2.0789E−06 |
| S2 | −4.1785E−03 | 4.2090E−04 | −3.3951E−03 | 3.2458E−03 | −1.4317E−03 | 3.5885E−04 | −5.2624E−05 |
| S3 | −4.6572E−03 | 4.1243E−03 | −6.5135E−03 | 4.8980E−03 | −1.9099E−03 | 4.0932E−04 | −4.1890E−05 |
| S4 | −7.7749E−03 | 7.1432E−03 | −3.9210E−03 | 4.1187E−04 | 1.1311E−03 | −8.5004E−04 | 2.9502E−04 |
| S5 | −1.7113E−02 | 4.8796E−03 | −2.0116E−03 | −1.1523E−05 | 4.8429E−04 | −2.7480E−04 | 7.3276E−05 |
| S6 | −7.8934E−03 | −2.0006E−04 | 1.3713E−03 | −1.7925E−03 | 1.2025E−03 | −4.8610E−04 | 1.1707E−04 |
| S7 | −2.0128E−02 | 3.8099E−03 | −1.0557E−02 | 1.4806E−02 | −1.5383E−02 | 1.1834E−02 | −6.7582E−03 |
| S8 | −2.6036E−02 | 3.0878E−02 | −6.4668E−02 | 9.0546E−02 | −8.9461E−02 | 6.3434E−02 | −3.2446E−02 |
| S9 | −8.7026E−03 | 9.9166E−03 | −1.3077E−02 | 1.4804E−02 | −1.3051E−02 | 8.9559E−03 | −4.1729E−03 |
| S10 | −3.0680E−03 | −2.7406E−02 | 5.0909E−02 | −5.7270E−02 | 4.3504E−02 | −2.3311E−02 | 9.0203E−03 |
| S11 | −1.9740E−02 | 1.1071E−02 | −9.1083E−03 | 6.5020E−03 | −3.4575E−03 | 1.2855E−03 | −3.3140E−04 |
| S12 | −4.3860E−02 | 2.1767E−02 | −1.3054E−02 | 7.2149E−03 | −3.1045E−03 | 9.7494E−04 | −2.2138E−04 |
| S13 | −2.5554E−02 | 6.3600E−03 | −4.4762E−03 | 2.7530E−03 | −1.1482E−03 | 3.2028E−04 | −6.1460E−05 |
| S14 | 9.6244E−03 | −8.1455E−03 | 3.0773E−03 | −8.3846E−04 | 1.5740E−04 | −1.9999E−05 | 1.6633E−06 |
| S15 | −2.3216E−02 | 3.0766E−03 | 1.0717E−04 | −1.7191E−04 | 2.7188E−05 | −3.6827E−06 | 3.2849E−07 |
| S16 | −2.3020E−02 | 1.6879E−03 | 5.6090E−04 | −2.4885E−04 | 4.9937E−05 | −6.3289E−06 | 5.4939E−07 |

TABLE 6-2

| Surface number | A18 | A20 | A22 | A24 | A26 | A28 | A30 |
|---|---|---|---|---|---|---|---|
| S1 | 2.2841E−07 | −1.0190E−08 | 0.0000E+00 | 0.0000E+00 | 0.0000E+00 | 0.0000E+00 | 0.0000E+00 |
| S2 | 4.2080E−06 | −1.4181E−07 | 0.0000E+00 | 0.0000E+00 | 0.0000E+00 | 0.0000E+00 | 0.0000E+00 |
| S3 | 1.3604E−07 | 3.3763E−07 | −1.9898E−08 | 0.0000E+00 | 0.0000E+00 | 0.0000E+00 | 0.0000E+00 |
| S4 | −5.6345E−05 | 5.7348E−06 | −2.4487E−07 | 0.0000E+00 | 0.0000E+00 | 0.0000E+00 | 0.0000E+00 |
| S5 | −9.3742E−06 | 4.6140E−07 | 0.0000E+00 | 0.0000E+00 | 0.0000E+00 | 0.0000E+00 | 0.0000E+00 |
| S6 | −1.5102E−05 | 8.0483E−07 | 0.0000E+00 | 0.0000E+00 | 0.0000E+00 | 0.0000E+00 | 0.0000E+00 |
| S7 | 2.8718E−03 | −9.0895E−04 | 2.1347E−04 | −3.6588E−05 | 4.3766E−06 | −3.2854E−07 | 1.1637E−08 |
| S3 | 1.2090E−02 | −3.2819E−03 | 6.4172E−04 | −8.7993E−05 | 8.0253E−06 | −4.3706E−07 | 1.0752E−08 |
| S9 | 1.3696E−03 | −3.1856E−04 | 5.2265E−05 | −5.9171E−06 | 4.3977E−07 | −1.9291E−08 | 3.7787E−10 |
| S10 | −2.5469E−03 | 5.2459E−04 | −7.7903E−05 | 8.1174E−06 | −5.6280E−07 | 2.3306E−08 | −4.3598E−10 |
| S11 | 5.8997E−05 | −7.1097E−06 | 5.4822E−07 | −2.2899E−08 | 1.3517E−10 | 2.8494E−11 | −8.5034E−13 |
| S12 | 3.6428E−05 | −4.3362E−06 | 3.6926E−07 | −2.1921E−08 | 8.6138E−10 | −2.0134E−11 | 2.1193E−13 |
| S13 | 8.2800E−06 | −7.8935E−07 | 5.2983E−08 | −2.4502E−09 | 7.4363E−11 | −1.3344E−12 | 1.0739E−14 |
| S14 | −8.0517E−08 | 9.9433E−10 | 1.4085E−10 | −1.0316E−11 | 3.3793E−13 | −5.7113E−15 | 4.0323E−17 |
| S15 | −2.0192E−08 | 8.7261E−10 | −2.6543E−11 | 5.5762E−13 | −7.7147E−15 | 6.3323E−17 | −2.3381E−19 |
| S16 | −3.3673E−08 | 1.4705E−09 | −4.5466E−11 | 9.7208E−13 | −1.3666E−14 | 1.1364E−16 | −4.2350E−19 |

FIG. 6A shows a longitudinal aberration curve of the optical imaging lens assembly of Embodiment 3, which represents deviations of a convergence focal point after lights with different wavelengths pass through the lens. FIG. 6B shows an astigmatism curve of the optical imaging lens assembly of Embodiment 3, which represents a tangential image surface curvature and a sagittal image surface curvature. FIG. 6C shows a distortion curve of the optical imaging lens assembly of Embodiment 3, which represents distortion values corresponding to different image heights. FIG. 6D shows a lateral color curve of the optical imaging lens assembly of Embodiment 3, which represents deviations of different image heights on the imaging surface after light passes through the lens. According to FIGS. 6A-6D, the optical imaging lens assembly provided in Embodiment 3 may achieve a good imaging quality.

### Embodiment 4

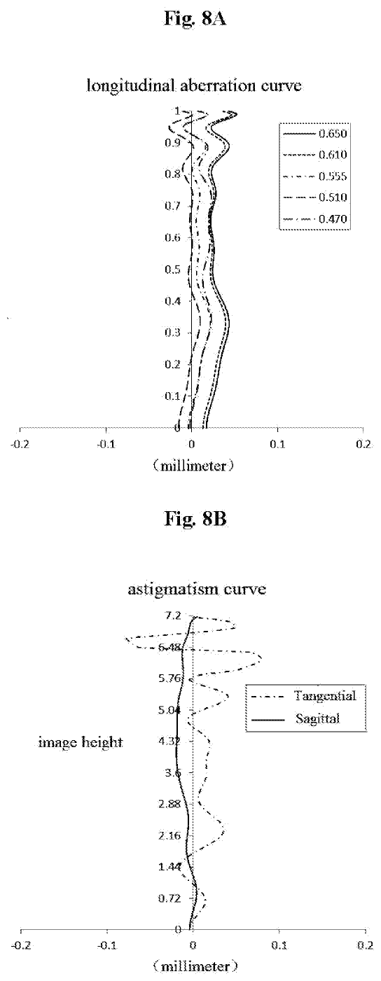

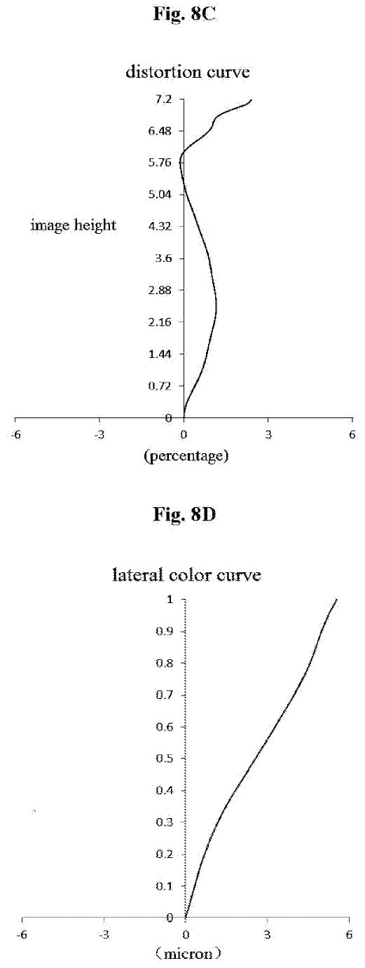

An optical imaging lens assembly according to Embodiment 4 of the disclosure is described below with reference to FIGS. 7-8D. FIG. 7 shows a structural schematic diagram of an optical imaging lens assembly according to Embodiment 4 of the disclosure.

As shown in FIG. 7, the optical imaging lens assembly includes sequentially from an object side to an image side: a diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a positive refractive power, an object-side surface S9 thereof is a concave surface, and an image-side surface S10 thereof is a convex surface. The sixth lens E6 has a positive refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 7.59 mm, TTL is a total length of the optical imaging lens assembly, and TTL is 9.62 mm, ImgH is a half of a diagonal length of an effective pixel region on the imaging surface S19 of the optical imaging lens assembly, and ImgH is 7.20 mm.

Table 7 shows a basic parameter table of the optical imaging lens assembly of Embodiment 4, wherein units of the curvature radius, the thickness/distance, and the focal length are all millimeters (mm). Tables 8-1 and 8-2 show high-order coefficients which may be used for each aspheric lens surface in Embodiment 4, wherein each aspheric surface type may be defined by formula (1) given in Embodiment 1 above.

TABLE 7

| | | | | Materials | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | 2000.0000 | | | | |
| STO | Spherical | Infinity | −0.9997 | | | | |
| S1 | Aspheric | 3.4454 | 1.1780 | 1.54 | 56.1 | 9.51 | 0.0111 |
| S2 | Aspheric | 9.0226 | 0.0490 | | | | −0.1762 |
| S3 | Aspheric | 6.9059 | 0.2948 | 1.67 | 19.2 | −20.55 | 0.1855 |
| S4 | Aspheric | 4.5367 | 0.1971 | | | | −0.0344 |
| S5 | Aspheric | 4.3126 | 0.3597 | 1.54 | 56.1 | 28.23 | 0.0368 |
| S6 | Aspheric | 5.8134 | 0.7436 | | | | 0.0059 |
| S7 | Aspheric | −909.0909 | 0.3600 | 1.67 | 19.2 | −34.39 | −49.6906 |
| S8 | Aspheric | 23.9159 | 0.0882 | | | | 9.2309 |
| S9 | Aspheric | −40.0837 | 0.8185 | 1.54 | 56.1 | 37.50 | −48.1991 |
| S10 | Aspheric | −13.6430 | 0.5022 | | | | −0.9875 |
| S11 | Aspheric | 9.6268 | 0.7349 | 1.57 | 37.3 | 66.61 | −0.8894 |
| S12 | Aspheric | 12.5366 | 0.3866 | | | | 0.5680 |
| S13 | Aspheric | 3.5034 | 0.7424 | 1.54 | 56.1 | 9.90 | −0.9831 |
| S14 | Aspheric | 9.2216 | 1.5070 | | | | 0.4250 |
| S15 | Aspheric | −6.3855 | 0.5957 | 1.54 | 55.7 | −5.76 | −0.0040 |
| S16 | Aspheric | 6.1946 | 0.4774 | | | | −0.0015 |
| S17 | Spherical | Infinity | 0.2100 | 1.52 | 64.2 | | |
| S18 | Spherical | Infinity | 0.3763 | | | | |
| S19 | Spherical | Infinity | | | | | |

TABLE 8-1

| Surface number | A4 | A6 | A8 | A10 | A12 | A14 | A16 |
|---|---|---|---|---|---|---|---|
| S1 | 1.8749E−04 | 3.0752E−04 | −4.9480E−04 | 4.0060E−04 | −1.8700E−04 | 5.2682E−05 | −8.8482E−06 |
| S2 | −4.0158E−03 | −4.0542E−04 | −2.2032E−03 | 2.3125E−03 | −9.9958E−04 | 2.3752E−04 | −3.2318E−05 |
| S3 | −4.5034E−03 | 4.0514E−03 | −9.0831E−03 | 1.2338E−02 | −1.2066E−02 | 8.8223E−03 | −4.6702E−03 |
| S4 | −4.9919E−03 | −7.4848E−03 | 3.7074E−02 | −7.0916E−02 | 8.2381E−02 | −6.3151E−02 | 3.2696E−02 |
| S5 | −1.9230E−02 | 2.1291E−02 | −5.8052E−02 | 1.1063E−01 | −1.4125E−01 | 1.2385E−01 | −7.6398E−02 |
| S6 | −6.0707E−03 | −9.4653E−03 | 3.5843E−02 | −8.1975E−02 | 1.2123E−01 | −1.2150E−01 | 8.4830E−02 |
| S7 | −9.3331E−03 | −5.5166E−02 | 1.6883E−01 | −3.3497E−01 | 4.4980E−01 | −4.2506E−01 | 2.8890E−01 |
| S8 | −2.6396E−02 | 3.5043E−02 | −8.3291E−02 | 1.2796E−01 | −1.3404E−01 | 9.8280E−02 | −5.1523E−02 |
| S9 | −9.3831E−03 | 1.6991E−02 | −3.3354E−02 | 4.4504E−02 | −4.0515E−02 | 2.5517E−01 | −1.1292E−02 |
| S10 | 1.1490E−03 | −3.7369E−02 | 6.6136E−02 | −7.3582E−02 | 5.6059E−02 | −3.0323E−02 | 1.1879E−02 |
| S11 | −2.1842E−02 | 1.7606E−02 | −1.9983E−02 | 1.7516E−02 | −1.0775E−02 | 4.6173E−03 | −1.3999E−03 |
| S12 | −4.6451E−02 | 2.7818E−02 | −2.0594E−02 | 1.2985E−02 | −6.0220E−03 | 1.9941E−03 | −4.7383E−04 |
| S13 | −2.5827E−02 | 7.6758E−03 | −6.5435E−03 | 4.3033E−03 | −1.8518E−03 | 5.3287E04 | −1.0605E−04 |
| S14 | 9.2264E−03 | −7.1920E−03 | 2.1038E−03 | −3.3907E−04 | 4.2388E−07 | 1.3169E−05 | −3.2497E−06 |
| S15 | −2.3216E−02 | 2.8837E−03 | 2.2494E−04 | −1.5313E−04 | 3.3664E−05 | −4.4679E−06 | 3.9356E−07 |
| S16 | −2.3724E−02 | 1.9158E−03 | 5.1585E−04 | −2.4549E−04 | 5.0593E−05 | −6.5262−06 | 5.7353E−07 |

TABLE 8-2

| Surface number | A18 | A20 | A22 | A24 | A26 | A28 | A30 |
|---|---|---|---|---|---|---|---|
| S1 | 8.1541E−07 | −3.1832E−08 | 0.0000E+00 | 0.0000E+00 | 0.0000E+00 | 0.0000E+00 | 0.0000E+00 |
| S2 | 2.3449E−06 | −6.9739E−08 | 0.0000E+00 | 0.0000E+00 | 0.0000E+00 | 0.0000E+00 | 0.0000E+00 |
| S3 | 1.7622E−03 | −4.7194E−04 | 8.9141E−05 | −1.1666E−05 | 1.0152E−06 | −5.3500E−08 | 1.3111E−09 |
| S4 | −1.1274E−02 | 2.4048E−03 | −2.3003E−04 | −2.2459E−05 | 9.5613E−06 | −1.1171E−06 | 4.8208E−08 |
| S5 | 3.3579E−02 | −1.0525E−02 | 2.3237E−03 | −3.5074E−04 | 3.4135E−05 | −1.9039E−06 | 4.5171E−08 |
| S6 | −4.1883E−02 | 1.4676E−02 | −3.6171E−03 | 6.1130E−04 | −6.7227E−05 | 4.3163E−06 | −1.2215E−07 |
| S7 | −1.4266E−01 | 5.1172E−02 | −1.3181E−02 | 2.3732E−03 | −2.8324E−04 | 2.0117E−05 | −6.4314E−07 |
| S8 | 1.9568E−02 | −5.3992E−03 | 1.0722E−03 | −1.4935E−04 | 1.3855E−05 | −7.6895E−07 | 1.9322E−08 |
| S9 | 3.5543E−03 | −7.9859E−04 | 1.2699E−04 | −1.3935E−05 | 1.0011E−06 | −4.2243E−08 | 7.9014E−10 |
| S10 | −3.3995E−03 | 7.0968E−04 | −1.0676E−04 | 1.1257E−05 | −7.8900E−07 | 3.2987E−08 | −6.2220E−10 |
| S11 | 3.0394E−04 | −4.7390E−05 | 5.2597E−06 | −4.0535E−07 | 2.0608E−08 | −6.2133E−10 | 8.4115E−12 |
| S12 | 8.1348E−05 | −1.0089E−05 | 8.9418E−07 | −5.5195E−08 | 2.2529E−09 | −5.4646E−11 | 5.9630E−13 |
| S13 | 1.4901E−05 | −1.4889E−06 | 1.0522E−07 | −5.1429E−09 | 1.6549E−10 | −3.1562E−12 | 2.7046E−14 |
| S14 | 4.3890E−07 | −3.8325E−08 | 2.2516E−09 | −8.8636E−11 | 2.2456E−12 | −3.3128E−14 | 2.1638E−16 |
| S15 | −2.3948E−08 | 1.0244E−09 | −3.0794E−11 | 6.3775E−13 | −8.6705E−15 | 6.9673E−17 | −2.5077E−19 |
| S16 | −3.5453E−08 | 1.5573E−09 | −4.8340E−11 | 1.0363E−12 | −1.4594E−14 | 1.2149E−16 | −4.5300E−19 |

FIG. 8A shows a longitudinal aberration curve of the optical imaging lens assembly of Embodiment 4, which represents deviations of a convergence focal point after lights with different wavelengths pass through the lens. FIG. 8B shows an astigmatism curve of the optical imaging lens assembly of Embodiment 4, which represents a tangential image surface curvature and a sagittal image surface curvature. FIG. 8C shows a distortion curve of the optical imaging lens assembly of Embodiment 4, which represents distortion values corresponding to different image heights. FIG. 8D shows a lateral color curve of the optical imaging lens assembly of Embodiment 4, which represents deviations of different image heights on the imaging surface after light passes through the lens. According to FIGS. 8A-8D, the optical imaging lens assembly provided in Embodiment 4 may achieve a good imaging quality.

### Embodiment 5

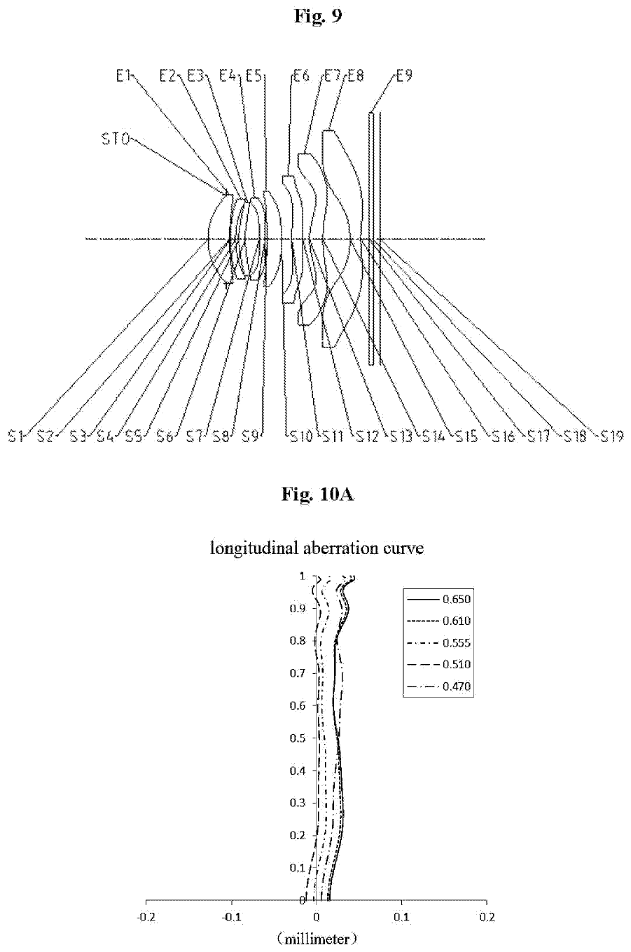

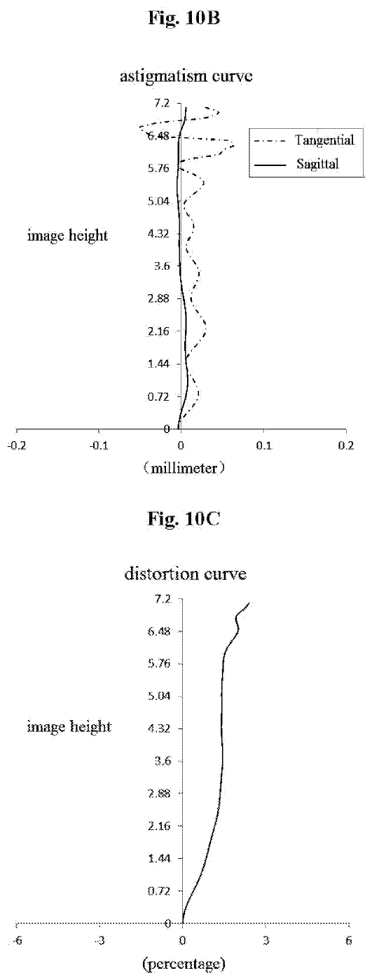

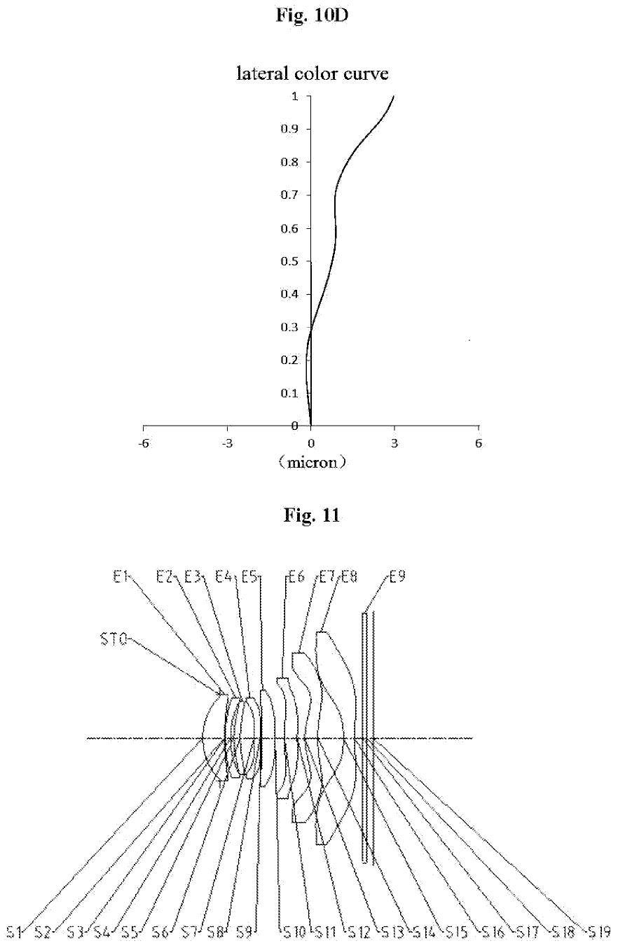

An optical imaging lens assembly according to Embodiment 5 of the disclosure is described below with reference to FIGS. 9-10D. FIG. 9 shows a structural schematic diagram of an optical imaging lens assembly according to Embodiment 5 of the disclosure.

As shown in FIG. 9, the optical imaging lens assembly includes sequentially from an object side to an image side: a diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a positive refractive power, an object-side surface S9 thereof is a concave surface, and an image-side surface S10 thereof is a convex surface. The sixth lens E6 has a negative refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 7.67 mm, TTL is a total length of the optical imaging lens assembly, and TTL is 9.63 mm, ImgH is a half of a diagonal length of an effective pixel region on the imaging surface S19 of the optical imaging lens assembly, and ImgH is 7.10 mm.

Table 9 shows a basic parameter table of the optical imaging lens assembly of Embodiment 5, wherein units of the curvature radius, the thickness/distance, and the focal length are all millimeters (mm). Tables 10-1 and 10-2 show high-order coefficients which may be used for each aspheric lens surface in Embodiment 5, wherein each aspheric surface type may be defined by formula (1) given in Embodiment 1 above.

TABLE 9

| | | | | Materials | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | 2000.0000 | | | | |
| STO | Spherical | Infinity | −1.0000 | | | | |
| S1 | Aspheric | 3.4430 | 1.2093 | 1.54 | 56.1 | 9.52 | 0.0145 |
| S2 | Aspheric | 8.9519 | 0.0431 | | | | −0.2401 |
| S3 | Aspheric | 6.7707 | 0.2930 | 1.67 | 19.2 | −20.19 | 0.0410 |
| S4 | Aspheric | 4.4502 | 0.1855 | | | | −0.0302 |
| S5 | Aspheric | 4.2922 | 0.3601 | 1.54 | 56.1 | 28.87 | 0.0194 |
| S6 | Aspheric | 5.7252 | 0.7789 | | | | 0.0713 |
| S7 | Aspheric | −303.0303 | 0.3476 | 1.67 | 19.2 | −32.58 | −50.0000 |
| S8 | Aspheric | 23.8183 | 0.0837 | | | | 13.7318 |
| S9 | Aspheric | −59.5441 | 0.8325 | 1.54 | 56.1 | 22.36 | 50.0000 |
| S10 | Aspheric | −10.1731 | 0.5710 | | | | −0.0539 |
| S11 | Aspheric | 12.2628 | 0.6138 | 1.57 | 37.3 | −61.69 | 1.4503 |
| S12 | Aspheric | 8.9283 | 0.3758 | | | | −0.3524 |
| S13 | Aspheric | 3.1362 | 0.7581 | 1.54 | 56.1 | 8.67 | −0.9696 |
| S14 | Aspheric | 8.5235 | 1.5070 | | | | 0.4190 |
| S15 | Aspheric | −6.3851 | 0.6086 | 1.54 | 55.7 | −5.76 | −0.0040 |
| S16 | Aspheric | 6.1948 | 0.4775 | | | | −0.0019 |
| S17 | Spherical | Infinity | 0.2100 | 1.52 | 64.2 | | |
| S18 | Spherical | Infinity | 0.3764 | | | | |
| S19 | Spherical | Infinity | | | | | |

TABLE 10-1

| Surface number | A4 | A6 | A8 | A10 | A12 | A14 | A16 |
|---|---|---|---|---|---|---|---|
| S1 | −1.0501E−04 | 8.6425E−04 | −1.0546E−03 | 7.2810E−04 | −3.0128E−04 | 7.6587E−05 | −1.1730E−05 |
| S2 | −4.1043E−03 | −3.5628E−05 | −2.7602E−03 | 2.7876E−03 | −1.2383E−03 | 3.1044E−04 | −4.5655E−05 |
| S3 | −4.5706E−03 | 3.9285E−03 | −6.3658E−03 | 5.0949E−03 | −2.2691E−03 | 6.3658E−04 | −1.1673E−04 |
| S4 | −7.5524E−03 | 5.8589E−03 | −1.1375E−03 | −2.7906E−03 | 3.3885E−03 | −1.8996E−03 | 6.2122E−04 |
| S5 | −1.6933E−02 | 5.0151E−03 | −3.0024E−03 | 1.3616E−03 | −5.6428E−04 | 1.8794E−04 | −4.2116E−05 |
| S6 | −6.9418E−03 | −1.5426E−03 | 3.1291E−03 | −3.4747E−03 | 2.1980E−03 | −8.5704E−04 | 2.0395E−04 |
| S7 | −1.6896E−02 | −1.3637E−02 | 4.0543E−02 | −8.1679E−02 | 1.1046E−01 | −1.0554E−01 | 7.2828E−02 |
| S8 | −2.0653E−02 | 7.7720E−03 | −1.3923E−02 | 1.9611E−02 | −2.1030E−02 | 1.5677E−02 | −8.0877E−03 |
| S9 | −8.9408E−03 | 1.0005E−02 | −1.4867E−02 | 1.9099E−02 | −1.8641E−02 | 1.2712E−02 | −5.9866E−03 |
| S10 | −8.8259E−03 | −3.2992E−03 | 6.8227E−03 | −6.7857E−03 | 4.2098E−03 | −1.6886E−03 | 4.2205E−04 |
| S11 | −1.9056E−02 | 1.1873E−02 | −1.0308E−02 | 7.7769E−03 | −4.4482E−03 | 1.8181E−03 | −5.3008E−04 |
| S12 | −4.5215E−02 | 1.8598E−02 | −8.1626E−03 | 3.5204E−03 | −1.3157E−03 | 3.7565E−04 | −7.8020E−05 |
| S13 | −2.7722E−02 | 7.8394E−03 | −4.8973E−03 | 2.6580E−03 | −1.0189E−03 | 2.6840E−04 | −4.9401E−05 |
| S14 | 8.8691E−03 | −5.7602E−03 | 1.2665E−03 | −8.2347E−05 | −4.4029E−05 | 1.6689E−05 | −3.0799E−06 |
| S15 | −2.3644E−02 | 3.5326E−03 | −1.1815E−04 | −5.8481E−05 | 1.7747E−05 | −2.7082E−06 | 2.6050E−07 |
| S16 | −2.4566E−02 | 2.8995E−03 | 5.1522E−05 | −1.1724E−04 | 2.8016E−05 | −3.8485E−06 | 3.5186E−07 |

TABLE 10-2

| Surface number | A18 | A20 | A22 | A24 | A26 | A28 | A30 |
|---|---|---|---|---|---|---|---|
| S1 | 9.9390E−07 | −3.5927E−08 | 0.0000E+00 | 0.0000E+00 | 0.0000E+00 | 0.0000E+00 | 0.0000E+00 |
| S2 | 3.6832E−06 | −1.2615E−07 | 0.0000E+00 | 0.0000E+00 | 0.0000E+00 | 0.0000E+00 | 0.0000E+00 |
| S3 | 1.3820E−05 | −9.7909E−07 | 3.2144E−08 | 0.0000E+00 | 0.0000E+00 | 0.0000E+00 | 0.0000E+00 |
| S4 | −1.2132E−04 | 1.3170E−05 | −6.1376E−07 | 0.0000E+00 | 0.0000E+00 | 0.0000E+00 | 0.0000E+00 |
| S5 | 5.6685E−06 | −3.3365E−07 | 0.0000E+00 | 0.0000E+00 | 0.0000E+00 | 0.0000E+00 | 0.0000E+00 |
| S6 | −2.6843E−05 | 1.4989E−06 | 0.0000E+00 | 0.0000E+00 | 0.0000E+00 | 0.0000E+00 | 0.0000E+00 |
| S7 | −3.6612E−02 | 1.3386E−02 | −3.5154E−03 | 6.4498E−04 | −7.8370E−05 | 5.6592E−06 | −1.8364E−07 |
| S8 | 2.9431E−03 | −7.6550E−04 | 1.4220E−04 | −1.8497E−05 | 1.6051E−06 | −8.3578E−08 | 1.9763E−09 |
| S9 | 1.9717E−03 | −4.5866E−04 | 7.5192E−05 | −8.5153E−06 | 6.3508E−07 | −2.8106E−08 | 5.5976E−10 |
| S10 | −5.1283E−05 | −3.9120E−06 | 2.7926E−06 | −5.2598E−07 | 5.2923E−08 | −2.8734E−09 | 6.6415E−11 |
| S11 | 1.1106E−04 | −1.6748E−05 | 1.8005E−06 | −1.3456E−07 | 6.6400E−09 | −1.9444E−10 | 2.5582E−12 |
| S12 | 1.1624E−05 | −1.2302E−06 | 9.0891E−08 | −4.5382E−09 | 1.4408E−10 | −2.5738E−12 | 1.8982E−14 |
| S13 | 6.4401E−06 | −5.9703E−07 | 3.9080E−08 | −1.7655E−09 | 5.2411E−11 | −9.2085E−13 | 7.2635E−15 |
| S14 | 3.6271E−07 | −2.9051E−08 | 1.6036E−09 | −6.0126E−11 | 1.4632E−12 | −2.0849E−14 | 1.3206E−16 |
| S15 | −1.6941E−08 | 7.6733E−10 | −2.4338E−11 | 5.3150E−13 | −7.6259E−15 | 6.4772E−17 | −2.4688E−19 |
| S16 | −2.2399E−08 | 1.0073E−09 | −3.1885E−11 | 6.9507E−13 | −9.9330E−15 | 8.3772E−17 | −3.1609E−19 |

FIG. 10A shows a longitudinal aberration curve of the optical imaging lens assembly of Embodiment 5, which represents deviations of a convergence focal point after lights with different wavelengths pass through the lens. FIG. 10B shows an astigmatism curve of the optical imaging lens assembly of Embodiment 5, which represents a tangential image surface curvature and a sagittal image surface curvature. FIG. 10C shows a distortion curve of the optical imaging lens assembly of Embodiment 5, which represents distortion values corresponding to different image heights. FIG. 10D shows a lateral color curve of the optical imaging lens assembly of Embodiment 5, which represents deviations of different image heights on the imaging surface after light passes through the lens. According to FIGS. 10A-10D, the optical imaging lens assembly provided in Embodiment 5 may achieve a good imaging quality.

### Embodiment 6

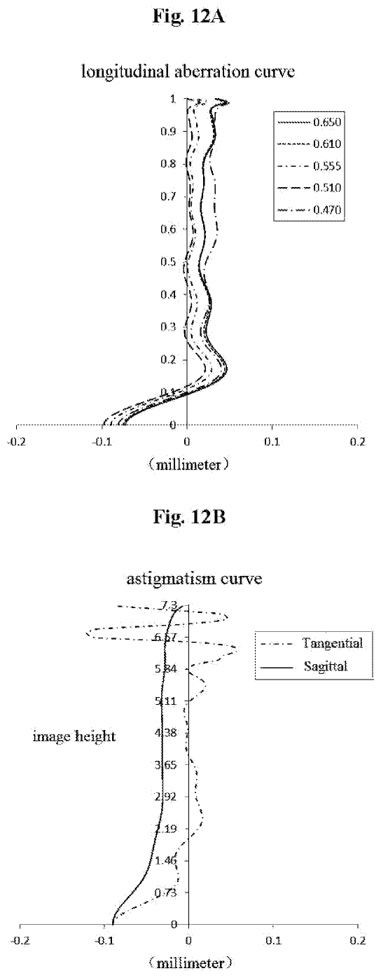

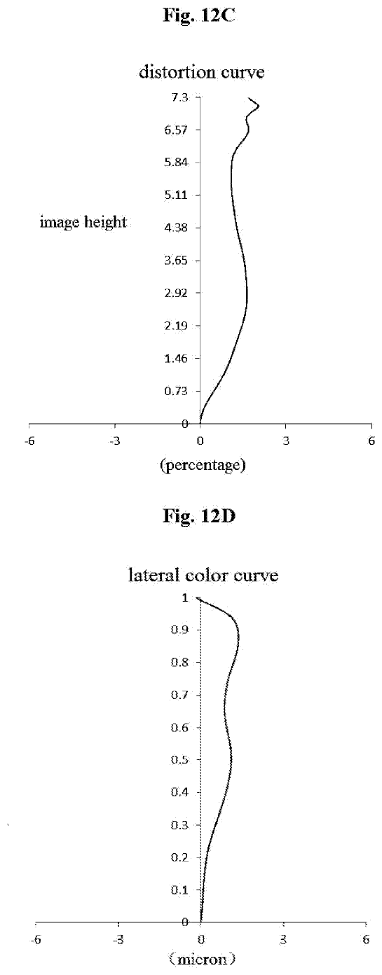

An optical imaging lens assembly according to Embodiment 6 of the disclosure is described below with reference to FIGS. 11-12D. FIG. 11 shows a structural schematic diagram of an optical imaging lens assembly according to Embodiment 6 of the disclosure.

As shown in FIG. 11, the optical imaging lens assembly includes sequentially from an object side to an image side: a diaphragm STO, a first lens E1, a second lens E2, a third lens E3, a fourth lens E4, a fifth lens E5, a sixth lens E6, a seventh lens E7, an eighth lens E8, an optical filter E9 and an imaging surface S19.

The first lens E1 has a positive refractive power, an object-side surface S1 thereof is a convex surface, and an image-side surface S2 thereof is a concave surface. The second lens E2 has a negative refractive power, an object-side surface S3 thereof is a convex surface, and an image-side surface S4 thereof is a concave surface. The third lens E3 has a positive refractive power, an object-side surface S5 thereof is a convex surface, and an image-side surface S6 thereof is a concave surface. The fourth lens E4 has a negative refractive power, an object-side surface S7 thereof is a concave surface, and an image-side surface S8 thereof is a concave surface. The fifth lens E5 has a positive refractive power, an object-side surface S9 thereof is a convex surface, and an image-side surface S10 thereof is a convex surface. The sixth lens E6 has a positive refractive power, an object-side surface S11 thereof is a convex surface, and an image-side surface S12 thereof is a concave surface. The seventh lens E7 has a positive refractive power, an object-side surface S13 thereof is a convex surface, and an image-side surface S14 thereof is a concave surface. The eighth lens E8 has a negative refractive power, an object-side surface S15 thereof is a concave surface, and an image-side surface S16 thereof is a concave surface. The optical filter E9 has an object-side surface S17 and an image-side surface S18. Light from an object sequentially penetrates through each of the surfaces S1 to S18 and is finally imaged on the imaging surface S19.

In the embodiment, f is a total effective focal length of the optical imaging lens assembly, and f is 7.57 mm, TTL is a total length of the optical imaging lens assembly, and TTL is 9.72 mm, ImgH is a half of a diagonal length of an effective pixel region on the imaging surface S19 of the optical imaging lens assembly, and ImgH is 7.29 mm.

Table 11 shows a basic parameter table of the optical imaging lens assembly of Embodiment 6, wherein units of the curvature radius, the thickness/distance, and the focal length are all millimeters (mm). Tables 12-1 and 12-2 show high-order coefficients which may be used for each aspheric lens surface in Embodiment 6, wherein each aspheric surface type may be defined by formula (1) given in Embodiment 1 above.

TABLE 11

| | | | | Materials | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinity | 2000.0000 | | | | |
| STO | Spherical | Infinity | −0.9855 | | | | |
| S1 | Aspheric | 3.4489 | 1.2356 | 1.54 | 56.1 | 9.50 | 0.0034 |
| S2 | Aspheric | 9.0145 | 0.0421 | | | | −0.1599 |
| S3 | Aspheric | 7.0062 | 0.3061 | 1.67 | 19.2 | −20.11 | 0.0513 |
| S4 | Aspheric | 4.5451 | 0.1834 | | | | −0.0440 |
| S5 | Aspheric | 4.3135 | 0.3711 | 1.54 | 56.1 | 28.42 | 0.0455 |
| S6 | Aspheric | 5.7945 | 0.7920 | | | | −0.1057 |
| S7 | Aspheric | −833.3333 | 0.3390 | 1.67 | 19.2 | −26.86 | 13.5742 |
| S8 | Aspheric | 18.6124 | 0.0654 | | | | 13.0981 |
| S9 | Aspheric | 47.1860 | 0.7957 | 1.54 | 56.1 | 31.28 | 0.9237 |
| S10 | Aspheric | −26.5761 | 0.5334 | | | | 9.9328 |
| S11 | Aspheric | 8.9067 | 0.7297 | 1.57 | 37.3 | 66.61 | 0.1284 |
| S12 | Aspheric | 11.2880 | 0.4356 | | | | 1.2538 |
| S13 | Aspheric | 3.3392 | 0.7418 | 1.54 | 56.1 | 9.49 | −0.9444 |
| S14 | Aspheric | 8.6662 | 1.4690 | | | | 0.3973 |
| S15 | Aspheric | −6.3830 | 0.6138 | 1.54 | 55.7 | −5.75 | −0.0040 |
| S16 | Aspheric | 6.1980 | 0.4801 | | | | −0.0025 |
| S17 | Spherical | Infinity | 0.2100 | 1.52 | 64.2 | | |
| S18 | Spherical | Infinity | 0.3790 | | | | |
| S19 | Spherical | Infinity | | | | | |

TABLE 12-1

| Surface number | A4 | A6 | A8 | A10 | A12 | A14 | A16 |
|---|---|---|---|---|---|---|---|
| S1 | −1.3742E−03 | 6.9712E−03 | −1.5889E−02 | 2.2300E−02 | −2.0650E−02 | 1.3190E−02 | −5.9729E−03 |
| S2 | −3.3741E−03 | −5.3853E−03 | 1.5158E−02 | −2.9264E−02 | 3.3989E−02 | −2.5431E−02 | 1.3038E−02 |
| S3 | −5.6787E−03 | 8.8828E−03 | −1.7184E−02 | 2.0150E−02 | −1.7331E−02 | 1.1797E−02 | −6.2195E−03 |
| S4 | −3.9407E−04 | −3.7314E−02 | 1.3945E−01 | −2.8385E−01 | 3.7331E−01 | −3.3787E−01 | 2.1749E−01 |
| S5 | −2.3556E−02 | 4.2554E−02 | −1.1585E−01 | 2.0877E−01 | −2.5207E−01 | 2.1054E−01 | −1.2452E−01 |
| S6 | −4.5908E−03 | −2.1094E−02 | 7.7261E−02 | −1.6631E−01 | 2.3226E−01 | −2.2198E−01 | 1.4956E−01 |
| S7 | −2.6218E−02 | 3.8677E−02 | −1.2177E−01 | 2.3582E−01 | −3.0976E−01 | 2.8637E−01 | −1.9074E−01 |
| S8 | −2.3413E−02 | 2.2185E−02 | −4.5114E−02 | 5.8703E−02 | −5.2229E−02 | 3.1852E−02 | −1.3292E−02 |
| S9 | −9.0512E−03 | 1.1124E−02 | −1.5839E−02 | 1.8582E−02 | −1.6786E−02 | 1.0827E−02 | −4.8791E−03 |
| S10 | −7.8085E−03 | −1.6184E−02 | 3.3424E−02 | −3.8394E−02 | 2.9130E−02 | −1.5403E−02 | 5.8315E−03 |
| S11 | −1.9157E−02 | 9.8445E−03 | −8.0454E−03 | 6.1159E−03 | −3.5354E−03 | 1.4441E−03 | −4.1667E−04 |
| S12 | −4.1266E−02 | 1.7490E−02 | −8.6871E−03 | 4.1730E−03 | −1.6362E−03 | 4.7800E−04 | −1.0179E−04 |
| S13 | −2.6194E−02 | 7.2457E−03 | −4.5702E−03 | 2.4078E−03 | −8.9016E−04 | 2.2669E−04 | −4.0429E−05 |
| S14 | 6.2967E−03 | −4.4996E−03 | 9.6818E−04 | −8.3619E−05 | −1.8901E−05 | 8.0206E−06 | −1.4522E−06 |
| S15 | −2.3770E−02 | 3.6246E−03 | −1.5530E−04 | −4.9430E−05 | 1.6311E−05 | −2.5546E−06 | 2.4919E−07 |
| S16 | −2.3373E−02 | 2.5925E−03 | 9.7878E−05 | −1.2025E−04 | 2.7464E−05 | −3.6825E−06 | 3.3112E−07 |

TABLE 12-2

| Surface number | A18 | A20 | A22 | A24 | A26 | A28 | A30 |
|---|---|---|---|---|---|---|---|
| S1 | 1.9455E−03 | −4.5724E−04 | 7.6826E−05 | −8.9968E−06 | 6.9725E−07 | −3.2129E−08 | 6.6615E−10 |
| S2 | −4.7351E−03 | 1.2337E−03 | −2.2962E−04 | 2.9842E−05 | −2.5757E−06 | 1.3278E−07 | −3.0963E−09 |
| S3 | 2.4538E−03 | −7.0664E−04 | 1.4530E−04 | −2.0683E−05 | 1.9307E−06 | −1.0604E−07 | 2.5908E−09 |
| S4 | −1.0119E−01 | 3.4141E−02 | −8.2762E−03 | 1.4050E−03 | −1.5857E−04 | 1.0687E−05 | −3.2550E−07 |
| S5 | −5.2769E−02 | −1.6026E−02 | 3.4446E−03 | −5.0874E−04 | 4.8740E−05 | −2.6973E−06 | 6.4277E−08 |
| S6 | −7.2132E−02 | 2.4984E−02 | −6.1573E−03 | 1.0524E−03 | −1.1839E−04 | 7.8696E−06 | −2.3368E−07 |
| S7 | 9.2621E−02 | −3.2822E−02 | 8.3961E−03 | −1.5094E−03 | 1.8087E−04 | −1.2969E−05 | 4.2088E−07 |
| S8 | 3.7435E−03 | −6.7702E−04 | 6.6047E−05 | −1.4437E−07 | −7.7346E−07 | 8.3304E−08 | −3.0196E−09 |
| S9 | −1.5438E−03 | −3.4484E−04 | 5.4115E−05 | −5.8388E−06 | 4.1242E−07 | −1.7167E−08 | 3.1903E−10 |
| S10 | −1.6004E−03 | 3.1876E−04 | −4.5584E−05 | 4.5588E−06 | −3.0257−07 | 1.1968E−08 | −2.1346E−10 |
| S11 | 8.56777E−05 | −1.2582E−05 | 1.3072E−06 | −9.3629E−08 | 4.3870E−09 | −1.2064E−10 | 1.4706E−12 |
| S12 | 1.5763E−05 | −1.7681E−06 | 1.4194E−07 | −7.9478E−09 | 2.9504E−10 | −6.5339E−12 | 6.5448E−14 |
| S13 | 5.1061E−06 | −4.5713E−07 | 2.8716E−08 | −1.2334E−09 | 3.4370E−11 | −5.5743E−13 | 3.9693E−15 |
| S14 | 1.6521E−07 | −1.2757E−08 | 6.7894E−10 | −2.4542E−11 | 5.7551E−13 | −7.8959E−15 | 4.8103E−17 |
| S15 | −1.6362E−08 | 7.4669E−10 | −2.3836E−11 | 5.2354E−13 | −7.5520E−15 | 6.4475E−17 | −2.4702E−19 |
| S16 | −2.0814E−08 | 9.2643E−10 | −2.9065E−11 | 6.2843E−13 | −8.9113E−15 | 7.4591E−17 | −2.7937E−19 |

FIG. 12A shows a longitudinal aberration curve of the optical imaging lens assembly of Embodiment 6, which represents deviations of a convergence focal point after lights with different wavelengths pass through the lens. FIG. 12B shows an astigmatism curve of the optical imaging lens assembly of Embodiment 6, which represents a tangential image surface curvature and a sagittal image surface curvature. FIG. 12C shows a distortion curve of the optical imaging lens assembly of Embodiment 6, which represents distortion values corresponding to different image heights. FIG. 12D shows a lateral color curve of the optical imaging lens assembly of Embodiment 6, which represents deviations of different image heights on the imaging surface after light passes through the lens. According to FIGS. 12A-12D, the optical imaging lens assembly provided in Embodiment 6 may achieve a good imaging quality.

In summary, Embodiment 1 to Embodiment 6 satisfy relationships as shown in Table 13, respectively.

TABLE 13

| | embodiment | | | | | |
|---|---|---|---|---|---|---|
| Conditional expression | 1 | 2 | 3 | 4 | 5 | 6 |
| ImgH × EPD/f (mm) | 4.76 | 4.61 | 4.67 | 4.64 | 4.57 | 4.79 |
| f × tan(FOV/2) (mm) | 7.24 | 6.98 | 7.10 | 6.98 | 6.89 | 6.97 |
| ImgH × ImgH/TTL (mm) | 5.77 | 5.33 | 5.45 | 5.39 | 5.23 | 5.47 |
| (R1 + R2)/f1 | 1.32 | 1.29 | 1.31 | 1.31 | 1.30 | 1.31 |
| f4/(f2 + f8) | 1.28 | 1.71 | 1.59 | 1.31 | 1.26 | 1.04 |
| (f5 + f7)/f3 | 0.85 | 1.04 | 1.40 | 1.68 | 1.07 | 1.43 |
| (R3 + R4)/(R5 + R6) | 1.24 | 1.18 | 1.17 | 1.13 | 1.12 | 1.14 |
| (R14 + R13)/(R14 − R13) | 2.26 | 2.16 | 2.33 | 2.23 | 2.16 | 2.25 |
| f123/(CT1 + CT2 + CT3) | 6.58 | 6.01 | 5.90 | 5.68 | 5.67 | 5.48 |
| f67/(CT6 + T67 + CT7) | 5.79 | 5.96 | 4.97 | 4.75 | 5.88 | 4.48 |
| (SAG21 + SAG22)/ | 1.31 | 1.39 | 1.40 | 1.51 | 1.51 | 1.48 |
| (SAG31 + SAG32) | | | | | | |
| CT5/ET5 | 3.67 | 2.81 | 3.02 | 2.51 | 3.26 | 3.09 |
| (ET6 + ET8)/ET7 | 1.96 | 1.92 | 1.46 | 1.43 | 1.93 | 1.66 |

The disclosure also provides an imaging device, wherein the electronic photosensitive element may be a Charge Coupled Device (CCD) or a Complementary Metal Oxide Semiconductor (CMOS). The imaging device may be a stand-alone imaging device, such as a digital camera, or an imaging module integrated on a mobile electronic equipment, such as a cell phone. The imaging device is equipped with the optical imaging lens assembly described above.

The above description is only description about the specific embodiments of the disclosure and adopted technical principles. Those skilled in the art should know that the scope of disclosure involved in the disclosure is not limited to the technical solutions formed by specifically combining the technical features and should also cover other technical solutions formed by freely combining the technical features or equivalent features thereof without departing from the inventive concept, for example, technical solutions formed by mutually replacing the features and (but not limited to) the technical features with similar functions disclosed in the disclosure.

What is claimed is:

1. An optical imaging lens assembly, sequentially comprising from an object side to an image side along an optical axis:
a first lens with a positive refractive power, an object-side surface thereof is a convex surface, and an image-side surface thereof is a concave surface;
a second lens with a negative refractive power;
a third lens with a refractive power;
a fourth lens with a refractive power;
a fifth lens with a positive refractive power;
a sixth lens with a refractive power;
a seventh lens with a positive refractive power; and
an eighth lens with a negative refractive power;
wherein ImgH is a half of a diagonal length of an effective pixel region on an imaging surface of the optical imaging lens assembly, and ImgH, an entrance pupil diameter (EPD) of the optical imaging lens assembly and a total effective focal length f of the optical imaging lens assembly satisfy: 4.3 mm<ImgH×EPD/f<5.3 mm.

2. The optical imaging lens assembly according to claim 1, wherein an effective focal length f1 of the first lens, a curvature radius R1 of the object-side surface of the first lens and a curvature radius R2 of the image-side surface of the first lens satisfy: 1.0<(R1+R2)/f1<1.5.

3. The optical imaging lens assembly according to claim 1, wherein an effective focal length f4 of the fourth lens, an effective focal length f2 of the second lens and an effective focal length f8 of the eighth lens satisfy: 0.9<f4/(f2+f8)<1.9.

4. The optical imaging lens assembly according to claim 1, wherein an effective focal length f5 of the fifth lens, an effective focal length f7 of the seventh lens and an effective focal length f3 of the third lens satisfy: 0.7<(f5+f7)/f3<1.8.

5. The optical imaging lens assembly according to claim 1, wherein a curvature radius R5 of an object-side surface of the third lens, a curvature radius R6 of an image-side surface of the third lens, a curvature radius R3 of an object-side surface of the second lens and a curvature radius R4 of an image-side surface of the second lens satisfy: 1.0<(R3+R4)/(R5+R6)<1.5.

6. The optical imaging lens assembly according to claim 1, wherein a curvature radius R13 of an object-side surface of the seventh lens and a curvature radius R14 of an image-side surface of the seventh lens satisfy: 2.0<(R14+R13)/(R14−R13)<2.5.

7. The optical imaging lens assembly according to claim 1, wherein f123 is a combined focal length of the first lens, the second lens and the third lens, and f123, a center thickness CT1 of the first lens on the optical axis, a center thickness CT2 of the second lens on the optical axis and a center thickness CT3 of the third lens on the optical axis satisfy: 5.0<f123/(CT1+CT2+CT3)<7.0.

8. The optical imaging lens assembly according to claim 1, wherein f67 is a combined focal length of the sixth lens and the seventh lens, and f67, a center thickness CT6 of the sixth lens on the optical axis an air space T67 between the sixth lens and the seventh lens on the optical axis and a center thickness CT7 of the seventh lens on the optical axis satisfy: 4.2<f67/(CT6+T67+CT7)<6.2.

9. The optical imaging lens assembly according to claim 1, wherein SAG22 is a distance from an intersection point of an image-side surface of the second lens and the optical axis to an effective radius vertex of the image-side surface of the second lens on the optical axis, SAG21 is a distance from an intersection point of an object-side surface of the second lens and the optical axis to an effective radius vertex of the object-side surface of the second lens on the optical axis, SAG32 is a distance from an intersection point of an image-side surface of the third lens and the optical axis to an effective radius vertex of the image-side surface of the third lens on the optical axis, and SAG31 is a distance from an intersection point of an object-side surface of the third lens and the optical axis to an effective radius vertex of the object-side surface of the third lens on the optical axis, and SAG22, SAG21, SAG32 and SAG31 satisfy: 1.2<(SAG21+SAG22)/(SAG31+SAG32)<1.7.

10. The optical imaging lens assembly according to claim 1, wherein a center thickness CT5 of the fifth lens on the optical axis and an edge thickness ET5 of the fifth lens satisfy: 2.3<CT5/ET5<3.8.

11. The optical imaging lens assembly according to claim 1, wherein an edge thickness ET6 of the sixth lens, an edge thickness ET7 of the seventh lens and an edge thickness ET8 of the eighth lens satisfy: 1.2<(ET6+ET8)/(ET7)<2.2.

12. The optical imaging lens assembly according to claim 1, wherein FOV is a maximum field of view of the optical imaging lens assembly, and FOV and the total effective focal length f of the optical imaging lens assembly satisfy: 6.5 mm<f×tan(FOV/2)<7.5 mm.

13. The optical imaging lens assembly according to claim 1, wherein TTL is a distance on the optical axis from the object-side surface of the first lens to the imaging surface of the optical imaging lens assembly, and ImgH and TTL satisfy: 5.0 mm<ImgH×ImgH/TTL<6.0 mm.

14. An optical imaging lens assembly, sequentially comprising from an object side to an image side along an optical axis:
a first lens with a positive refractive power, an object-side surface thereof is a convex surface, and an image-side surface thereof is a concave surface;
a second lens with a negative refractive power;
a third lens with a refractive power;
a fourth lens with a refractive power;
a fifth lens with a positive refractive power;
a sixth lens with a refractive power;
a seventh lens with a positive refractive power; and
an eighth lens with a negative refractive power;
wherein FOV is a maximum field of view of the optical imaging lens assembly, and FOV and a total effective focal length f of the optical imaging lens assembly satisfy: 6.5 mm<f×tan(FOV/2)<7.5 mm.

15. The optical imaging lens assembly according to claim 14, wherein an effective focal length f1 of the first lens, a curvature radius R1 of the object-side surface of the first lens and a curvature radius R2 of the image-side surface of the first lens satisfy: 1.0<(R1+R2)/f1<1.5.

16. The optical imaging lens assembly according to claim 14, wherein an effective focal length f4 of the fourth lens, an effective focal length f2 of the second lens and an effective focal length f8 of the eighth lens satisfy: 0.9<f4/(f2+f8)<1.9.

17. The optical imaging lens assembly according to claim 14, wherein an effective focal length f5 of the fifth lens, an effective focal length f7 of the seventh lens and an effective focal length f3 of the third lens satisfy: 0.7<(f5+f7)/f3<1.8.

18. The optical imaging lens assembly according to claim 14, wherein a curvature radius R5 of an object-side surface of the third lens, a curvature radius R6 of an image-side surface of the third lens, a curvature radius R3 of an object-side surface of the second lens and a curvature radius R4 of an image-side surface of the second lens satisfy: 1.0<(R3+R4)/(R5+R6)<1.5.

19. The optical imaging lens assembly according to claim 14, wherein a curvature radius R13 of an object-side surface of the seventh lens and a curvature radius R14 of an image-side surface of the seventh lens satisfy: 2.0<(R14+R13)/(R14−R13)<2.5.

20. The optical imaging lens assembly according to claim 14, wherein f123 is a combined focal length of the first lens, the second lens and the third lens, and f123, a center thickness CT1 of the first lens on the optical axis, a center thickness CT2 of the second lens on the optical axis and a center thickness CT3 of the third lens on the optical axis satisfy: 5.0<f123/(CT1+CT2+CT3)<7.0.
